(19) United States
(12) Patent Application Publication
(10) Pub. No.: US 2002/0103673 A1
(43) Pub. Date: Aug. 1, 2002

(54) Methods and apparatus for facilitating the provision of services

(76) Inventor: Lindsay T. Atwood, South Jordan, UT (US)

Correspondence Address: DORSEY & WHITNEY, LLP, SUITE 4700, 370 SEVENTEENTH STREET, DENVER, CO, 80202-5647, US

(21) Appl. No.: 09/933,587

(22) Filed: Aug. 20, 2001

Related U.S. Application Data
(60) Provisional application No. 60/266,206, filed on Feb. 1, 2001.

(51) Int. Cl. G06F 17/60

(52) U.S. Cl. 705/2

(57) ABSTRACT

A method and system for facilitating the provision of services including the administration of a Web-based system that allows for pre-screening, scheduling, and statistical tracking of data in real time.

### CROSS REFERENCE TO RELATED APPLICATION

This nonprovisional application claims priority to U.S. provisional application No. 60/266,206 filed on Feb. 1, 2001, entitled METHODS AND APPARATUS FOR FACILITATING THE PROVISION OF HEALTH SERVICES. This Provisional Application is hereby incorporated by reference in its entirety as though fully set forth herein.

### BACKGROUND OF INVENTION

1. Field of the Invention

This invention is directed toward business models and Web-based systems for providing services. “Web-based systems” include systems that comprise one or more sites on a global computer network (e.g., one or more sites on the World Wide Web portion of the Internet). More specifically, it relates to business models and Web-based systems for providing health services, such as vision services, to members of corporations and health plans.

2. Background Art

The vision industry generates revenues in excess of $20 billion per year. Fifty-one percent of the American population has vision correction needs. Such a large market with an extraordinary revenue stream provides a healthy incentive for entrepreneurial business people to offer better services to health care providers, doctors, and patients.

Currently, there are multiple existing companies and business models targeted to various aspects of the vision industry and designed to bring patients together with health plans and doctors. For one reason or another, however, these models can all be improved. A number of these companies and business models are discussed below.

The first existing model is the “Optometric Co-Management Model.” This model fosters relationships with optometrists and relies on optometric referrals for their patient base. Optometrists receive a large co-management fee and provide post-operative visits for the patients. This model traditionally charges the highest fee for laser vision correction. This model has worked well in the past, but does not allow for a reduction in the laser vision correction price due to the co-management fees involved.

The second existing model is the “Mobile Laser Model.” In this model, a company creates a partnership with independent surgeons. The company (such as a laser center) provides the laser and technical support, and the doctor provides space for the laser and performs the procedure. Doctors lease the laser from the company on a per procedure basis and set their fees as they see fit. Two main problems occur in this model. First, physicians that do well build a following and end up leaving and purchasing their own laser. Second, many physicians have a hard time building a practice because of poor marketing or an inability to differentiate themselves from other refractive providers.

The third existing model is an “Open Access Laser Center Model.” In this model, companies build fixed laser centers and allow surgeons to market themselves and perform procedures at the fixed location for a facility fee. This model has the same shortcomings as those described above, namely, the doctors who do well brand themselves rather than the center and end up negotiating a lower cost per procedure or leave and open their own center.

The last existing model is a “Laser Vision Correction Discounters Model.” In this model, health services providers are aggressive in finding markets where price compression has not occurred and open discount centers with prices starting at lower than average rates. Independent surgeons that follow this model opt to offer laser vision correction at competitive prices to guard against the intrusion of a low cost leader. The problem with this model is that the companies and the independent surgeons compete on price alone. The patient who goes to one of these centers will change providers if the patient finds a better price. This has resulted in price wars and shrinking profits.

### SUMMARY OF INVENTION

The present invention represents a new and innovative business model and Web-based system for various services industries. In this model, a services facilitator establishes multi-year contracts with organizations, such as corporations, to gain access to their members and offer them services, such as health services, at discounted prices with no fees or premiums to the members of the organizations. The services facilitator handles the marketing to the members, and the development and contracting of the services provider network. This is tied together through the services facilitator's complete customer service center. As a third party administrator, the services facilitator uses a unique Web-based pre-screening, scheduling, and outcomes system for handling the services program. The services facilitator's database system is another feature of the present invention. Both systems allow for quick scalability in handling large call surges for the large number of contracted members, such as organization members and corporate employees. The services facilitator's systems link the customer service center, organizations, and services providers to a central service and administrative center.

In a health services example, the health services facilitator controls the patient flow of its health services program to its contracted provider network. In return, the provider network offers steep discounts for services, such as laser vision correction ( e.g., LASIK or PRK), contact lenses (ordered through the health services facilitator), and eyeglasses and eye exams through contracted health services providers.

The services facilitator contracts with organizations and manages the marketing, administration, scheduling, outcomes, and toll-free customer service for all parties involved. In exchange for the co-branding and endorsement from the organization for the services facilitator's program, the services facilitator offers its services to organization members at no additional cost to the members. The only cost to these members is the actual cost of the products or services purchased. The services facilitator carries no inventory of products and does not act as a services provider. Revenue for the services facilitator is generated from marketing referrals and from purchases made by the contracted plan members in the services facilitator's network.

Through relationships with services providers (such as laser companies, independent refractive surgeons, and laser centers) and organizations (such as health plans and their millions of health plan members), the services facilitator negotiates, for example, favorable prices for health services that are substantially below the national average. In exchange for bringing the organization members to the services providers, the services facilitator receives a marketing and administrative fee for every member that schedules a service through the services facilitator. In addition, the services facilitator receives the benefit of co-branding and endorsement from the organizations and services providers.

With respect to health services and products such as contact lenses, the members contact a health services facilitator via a communications link, such as a toll-free telephone number or a Web-based system. The member receives low prices on contact lenses, and the lenses are shipped directly to the member's door. The advantage of the health services facilitator's program comes from the negotiated relationships with contact lens manufacturers, who have agreed to ship contacts directly to members of contracted organizations, such as health plan members and corporate employees. This decreases the health services facilitator's shipping costs and eliminates the need to keep an inventory of contact lenses.

With respect to health services and products such as eyeglasses, the health services facilitator contracts with health services providers such as eyeglass vendors to provide frames, lenses, and eye exams to the members of contracted organizations.

The health services facilitator negotiates with these health services providers to offer substantial discounts to members. Lenses and eye exams are discounted from usual and customary prices otherwise charged by the health services providers. For example, eyeglasses that typically retail for $250-$300 can be purchased by the members for $100. These discounts are offered on all frames in the store.

Health services providers accept these reduced prices because of the health services facilitator's ability to redirect organization members to participating health services providers. The eyeglass program in this model refers organization members to health services providers, such as optical stores, for discounts on eyeglasses, frames, and eye exams. Members can generally purchase frames for about 25% above wholesale and receive discounts of up to 20% on lenses and eye exams.

The following are several of the advantages associated with this unique business model and Web-based system.

With respect to health services, such as vision services, this is the first business model to offer a full array of vision products with no monthly premiums or access fees. The health services facilitator also provides virtually all administrative functions at no extra cost. This is also the first business model in the vision industry to utilize sophisticated Web-based systems.

In the mail-order contact lens market segment, this unique model allows for members of contracted organizations to purchase directly from the contact lens manufacturer. This strategic benefit is enjoyed because health services providers view the health services facilitator's program as an efficient way to gain access to member-based organizations, such as health plans.

The Web-based system makes the administrative functions seamless to the organizations and their members, as well as to health services providers, such as laser centers, and contact lens manufacturers.

The Web-based system also enables the health services facilitator to schedule patients to any health services provides without calling the provider location or transferring the member. The system allows any provider to update schedules in real time. The system also tracks completed procedures, cancellations, reasons for cancellations, procedure outcomes, and statistical data on the procedures used by each provider. It is the only system that links independent providers through a single tracking, scheduling, and outcomes Web-based system.

The Web-based system provides for the creation of utilization reports that outline member information specific to each individual organization. This Web-based system also allows for tracking of providers procedure data such as customer satisfaction, procedural success rates, and types of equipment used. All of this information is stored in a database and is fully searchable and can be filtered into virtually a limitless number of reports detailing various information desired by health services providers, health services facilitators, and organizations.

An additional benefit of the present invention is the offering of a lifetime enhancement warranty for procedures such as laser vision correction. Procedures such as laser vision correction often require fine-tuning or enhancement after the initial procedure. In the event that an enhancement is needed, the lifetime warranty covers all costs except for the equipment manufacturer's licensing fee. This enhancement warranty is offered for life so long as the member has an annual eye exam with a participating services provider. Not only is this a valuable service to members, but it also allows for tracking of long-term outcomes and for screening for medical conditions that, if caught early, will help the members in the retention of their enhanced vision.

In addition to offering long-term care and long-term outcome tracking, the enhancement warranty creates a long-term revenue model.

The Web-based system automatically notifies organizations and/or members of scheduled appointments or as a reminder to schedule an annual exam.

The present invention also provides a method of facilitating the provision of services to individuals comprising the steps of establishing a services facilitator, establishing a first information sharing relationship between the services facilitator and an organization having a plurality of members wherein at least some of the plurality of members need certain services, and establishing a second information sharing relationship between the services facilitator and at least one services provider that provides the certain services. At least one inquiry is fielded from a member of the plurality of members and that member is referred to the services provider based upon the inquiry. In addition, the method provides for administration of a Web-based system that links the services facilitator to the services provider, possibly in real time.

The present invention also provides a method of receiving and processing information in real time over a network comprising the steps of establishing a site on a global communication network and providing a central server connected to the site, the central server being capable of accessing a dynamic database. The method also provides for recognizing an active scheduler, prompting the active scheduler with information stored by the central server to collect information for a plurality of fields within the dynamic database. The collected information is received from the active scheduler and processed by the central server. The dynamic database is then updated to reflect the collected information prior to recognizing a second active scheduler.

The present invention also provides a method of scheduling appointments and compiling statistical data in real time over a network comprising the steps of establishing a site on a global communications network; providing a central server connected to the network, the central server having a dynamic database; and recognizing at least one of a call center, a clinic, and an administrator as an active scheduler. The active scheduler is prompted to collect information for a plurality of fields within the dynamic database. The collected information is received from the active scheduler, stored, and updated in the dynamic database to reflect the collected information prior to recognizing a second active scheduler. The present invention also provides for scheduling appointments in real time based upon the collected information and makes details concerning the scheduled appointments selectively available over the global communication network. Statistical data is also compiled in real time based upon the collected information and details concerning the compiled statistical data are made selectively available over the global communication network.

The present invention also provides a system for linking a plurality of health services providers, a health services facilitator, and members to provide real-time scheduling of appointments, prequalification of members for specific services, and compilation of statistical tracking data over a network. The network has a central server, a communication link, and at least one remote communication terminal connected to the central server through a global computer network. The central server has a predetermined set of prompts and is capable of storing scheduling information, pre-qualifying information, and statistical tracking data pertaining to the health services providers, health services facilitator, and members in the database. The communication link allows the transfer of the scheduling information, pre-qualifying information, and statistical tracking data between the members and at least one of the health services providers and the health services facilitator. The health services providers and health services facilitator receive the predetermined prompts from the central server and enter the pre-qualifying information, scheduling information, and statistical tracking data obtained from the members through the communication link or independently entered by the health services providers and health services facilitator into the at least one remote communication terminal connected to the central server.

### BRIEF DESCRIPTION OF DRAWINGS

FIG. 1 is a schematic diagram illustrating a system for facilitating the provision of services in accordance with a first embodiment of the present invention;

FIG. 2 is a flow diagram illustrating a method of facilitating the provision of laser vision correction services in accordance with the first embodiment of the present invention;

FIG. 3 is a diagram illustrating a Web-based pre-screening, scheduling, and statistical tracking system in accordance with the present invention;

FIGS. 4A and 4B together comprise a flow diagram illustrating the Web-based pre-screening, scheduling, and statistical tracking system in accordance with the present invention;

FIG. 5 is a schematic diagram illustrating a system for facilitating the provision of contact lenses in accordance with a second embodiment of the present invention;

FIG. 6 is a schematic diagram illustrating a system for facilitating the provision of eyeglasses in accordance with a third embodiment of the present invention; and

FIGS. 7-48 illustrate exemplary screen shots in accordance with the flow diagram of FIGS. 4A and 4B.

### DETAILED DESCRIPTION

The present invention is directed toward a method and apparatus, including a Web-based system, for facilitating the provision of services to individuals. Generally, the present invention is directed to first establishing a services facilitator. The services facilitator in turn establishes relationships with services providers and organizations. The services facilitator offers discounted services to the organizations and refers the organizations and its members to various services providers. The Web-based system facilitates administration of these established relationships by allowing for scheduling of appointments, prequalification of individuals, tracking of statistical data, and processing orders, for example, all in real time. Although the invention is more broadly applicable, the following description refers to health services and more specifically to vision services, such as laser vision correction services, and contact lens and eyeglass programs. It is to be understood that the methods and Web-based system apply to other types of services as well. Further, the Web-based system itself is useful for any business that schedules appoints for multiple offices (services providers) through a central office (service facilitator). Such businesses may include, for example, restaurants, automobile repair shops, or law firms.

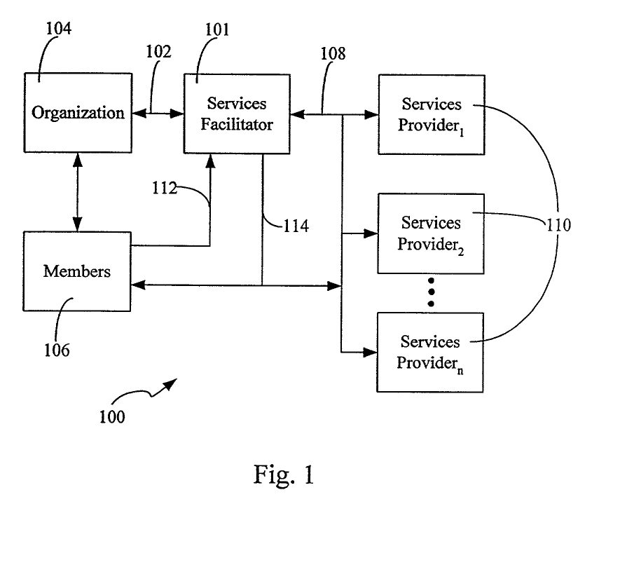

FIG. 1 is a schematic diagram illustrating a system 100 for facilitating the provision of services to members 106 of an organization 104 according to a first embodiment of the present invention. As illustrated in FIG. 1, this embodiment of the present invention comprises the steps of (a) establishing a services facilitator 101; (b) establishing a first information-sharing relationship 102 between the services facilitator 101 and an organization 104 having a plurality of members 106, wherein at least some of the plurality of members 106 need certain services; (c) establishing a second information-sharing relationship 108 between the services facilitator 101 and at least one services provider 110 that provides the certain services; (d) fielding at least one inquiry 112 from at least one of the plurality of members 106; and (e) referring 114 the member 106 to the services provider 110 based upon the inquiry 112.

The first information sharing relationship 102 is typically between the services facilitator 101 and a health plan or a corporation (“organization”) 104 having a plurality of plan members or employees (“members”) 106. The services facilitator 101 provides the organization 104 with numerous services providers 110 who have agreed to provide services at discounted rates. The organization 104 provides the services facilitator 101 with access to contact information for members 106 of the organization 104. Contact information includes, for example, work and home telephone numbers, work and home mailing addresses, and email addresses.

An additional aspect of the first information sharing relationship 102 is the co-branding of the services facilitator 101 with the organization 104. Preferably, the services facilitator and the organization collaborate to create marketing materials. These marketing materials co-brand the services facilitator 101 with the organization 104 by placing their logo or trade name alongside the services facilitator's logo or trade name and endorsing the program. It is believed that a large number of people choose a services provider based on a trusted referral, such as one by the organization. Thus, the co-branding of the services facilitator 101 with the organization 104 is quite valuable to the services facilitator 101 as well as to the services providers 110.

The second information sharing relationship 108 is typically between the services facilitator 101 and one or more services provider 110. The services provider 110 includes, for example, health services providers including independent laser chains, laser centers, and independent refractive surgeons. The services provider might also be the eye doctors who perform the annual examinations required by the lifetime enhancement warranty program discussed fully below. In the second information sharing relationship 108, the services facilitator 101 offers to refer 114 at least some of the members 106 of the contracted organization 104 to the services provider 110 in exchange for discounted rates from the services provider 110 on the particular services.

According to another aspect of the first embodiment, a lifetime enhancement warranty is offered by a health services facilitator 101 to the members 106. As is often the case with certain types of health services, such as laser vision correction, enhancement procedures may be required to fine tune, supplement, enhance, or correct the initial procedures. The method of the present invention provides these enhancement procedures at severely discounted rates, often for free. The health services facilitator 101 contracts 108 with health services providers 110 who waive all professional and facility fees in the event an enhancement is necessary. The only cost not covered is the equipment manufacturer-licensing fee for the laser vision correction equipment. Under the warranty, enhancements are offered for life, provided the member 106 schedules an annual eye exam through the health services facilitator 101 with a participating provider 110. The price of the eye exam is preferably about $60. This provides members 106 with a reasonably priced comprehensive eye exam as well as a continuation of their enhancement warranty. Members 106 are preferably reminded of the benefits derived from an annual eye exam and the continuation of their enhancement warranty through a direct mail reminder sent by the health services facilitator 101. Members may also be directly/automatically reminded to schedule an annual exam by email. The Web-based system described in detail below does this automatically. The eye exam fee is collected at the time the appointment is scheduled and is nonrefundable. The health services facilitator 101 tracks long-term outcomes and screens for medical conditions, which if identified will help the members in the retention of their enhanced vision.

The health services facilitator 101 preferably receives a fee for every member 106 who is referred 114 from the organization 104 to the health services provider 110. The health services facilitator also receives the benefit of the health services provider endorsing the health services facilitator's services.

Members 106 contact the health services facilitator 101, through a communications system, which is preferably a telephonic communication system, the Internet, or any other type of network of computers, telephones, or video conferencing equipment. Telephonic communication systems include, for example, voice telephone calls and facsimile or other data transmissions.

Each organization 104 in the health services facilitator's program is preferably provided with a specific toll-free telephone number. All calls (laser, contacts, and eyeglasses) are preferably to the health services facilitator 101 and are then routed based on the type of call. This allows the organization 104 to add the health services facilitator's Web-based system and method without adding administrative or call center staffing. Members 106 can also order contact lenses or find the closest health services provider through the Web-based system.

The health services facilitator 101 preferably includes a customer service center. The customer service center is either a part of the health services facilitator, as is the case with an in-house call center, or is linked to the health services facilitator through various cooperative relationships with overflow call centers to handle increased call volume. The overflow call centers also use the health services facilitator's Web-based system to provide seamless customer service for members 106 of the organization 104.

Preferably, the health services facilitator 101, through the customer service center, fields the inquiries 112 from the members 106. In the case of laser vision correction, the health services facilitator pre-screens the member to determine whether the member is a candidate for the laser vision correction procedure. If the member is a candidate, the health services facilitator 101 then refers 114 the member 106 to a participating health services provider 110 in close proximity to the member. The health services facilitator preferably schedules an initial examination with the appropriate health services provider at this point through the use of the Web-based system.

To schedule an examination, the member must provide a deposit via credit card while on the telephone. The health services facilitator keeps the entire deposit as an up-front fee for its services in handling the call and scheduling the procedure. The member goes to the exam and, if a candidate, schedules a laser vision correction procedure. The member pays the remaining balance of the surgical fee to the laser center on or before the day of surgery. If the member is not a candidate, a full refund is issued.

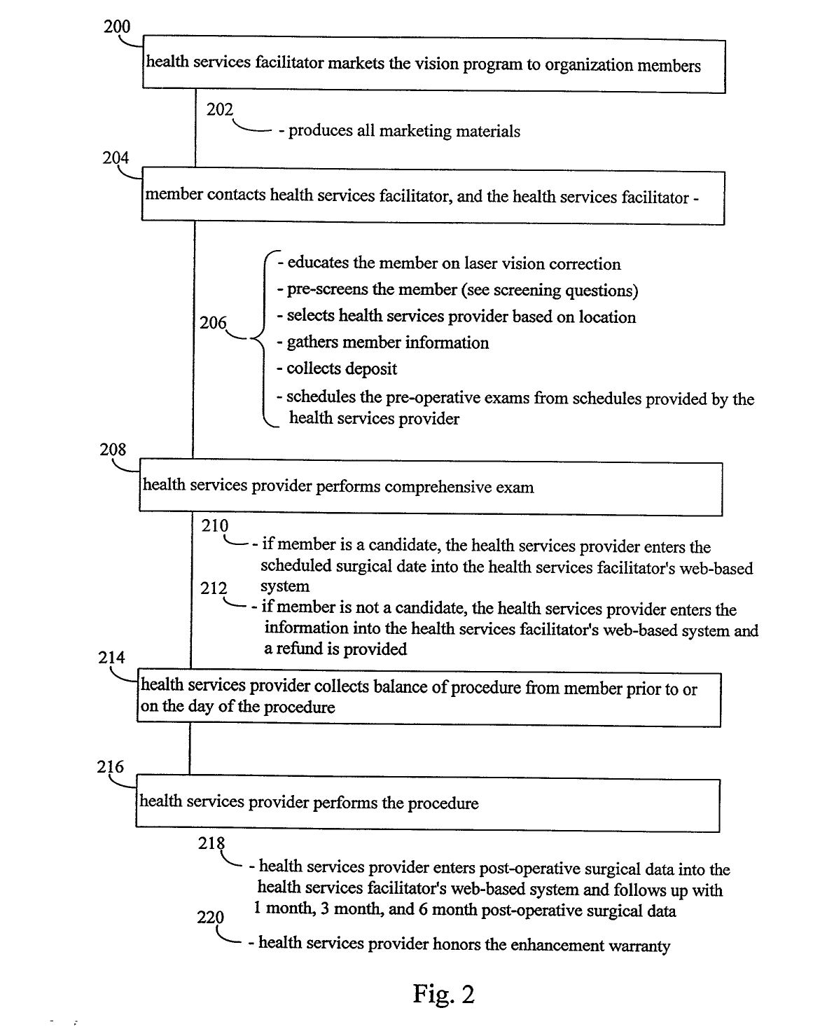

FIG. 2 is a flow diagram outlining the steps involved in the scheduling and tracking of laser vision correction surgery in accordance with one embodiment of the present invention, from a member's perspective. At block 200, the health services facilitator markets the laser vision correction program of the health services provider or providers to members of organizations. As part of its marketing efforts, the health services facilitator may produce all of the marketing materials as shown at 202, or the health services facilitator may work with the health services providers or others to produce the marketing materials, or the health services facilitator may merely distribute the marketing materials provided by another. At block 204, the members of the organization contact the health services facilitator through the customer service center. As shown at 206, the customer service center, through a Web-based system described in more detail below, educates the member on the laser vision correction procedure, pre-screens the member, selects a health services provider based on location, gathers member information, collects a deposit, and schedules a pre-operative exam from scheduling information uploaded to the Web-based system by the particular health services provider.

At block 208, the health services provider next performs a comprehensive exam to determine whether the member is a candidate for vision correction surgery. If the member is a candidate, the surgical date is entered into the health services facilitator's Web-based system as shown at 210. If the member is not a candidate, the appropriate information is entered into the health services facilitator's Web-based system, and the member's deposit is refunded, as shown at 212.

Assuming the member is a candidate for laser vision correction surgery, at block 214 the health services provider collects the balance of the cost for the laser vision correction surgery from the member. The health services provider preferably collects this balance prior to, or on the day of, the procedure. The member then has the procedure performed by the health services provider at block 216. The health services provider then enters the post-operative surgical data into the Web-based system at 218. This post-operative surgical data includes data obtained during all follow-up appointments. If vision enhancement is subsequently required, the health services provider performs the enhancement surgery and enters data relating to the enhancement into the health service facilitator's Web-based system at 220. This enhancement service is provided to assure quality of care on surgical outcomes.

This multi-party relationship (health services facilitator, organization, members, health services providers) is managed by a Web-based scheduling and outcome tracking system, which links all parties and allows for active, real-time scheduling of appointments for the members of participating organizations with the participating health services providers. This system also provides for tracking and detailed reporting of surgical data relating to various health services providers.

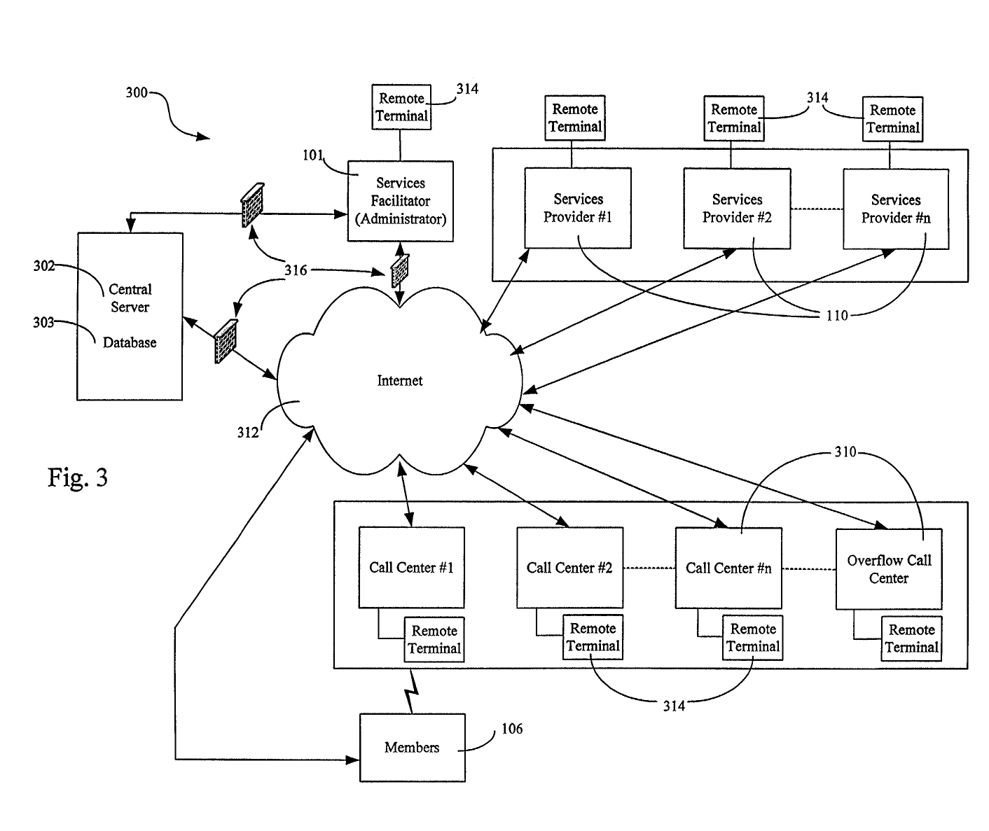

FIG. 3 shows a schematic overview of the Web-based scheduling and tracking system 300. The Web-based system 300 preferably includes a central server 302 capable of accessing a dynamic database 303, which is used to store information collected from members 106 as well as information entered by a services facilitator 101, one or more services providers 110, or call centers 310 associated with the services facilitator 101. The call centers 310, services facilitator 101, and services providers 110 are connected to the central server 302 preferably via the Internet 312. All information is entered into the Web-based system from remote terminals 314. The remote terminals are preferably personal computers.

Security of the information within the system 300 is provided for by restricted access to the central server 302 through login codes and passwords as well as the inclusion of numerous firewalls 316 to prevent access to the server 302 from unauthorized parties. These security techniques are known in the art and are easily implemented by one of ordinary skill.

Preferably, each services provider 110 is connected to the server 302 and consequently to the services facilitator 101 through the Web-based scheduling and surgical tracking system 300 so as to enable the services facilitator's customer service representatives in the customer service center (or call center 310) to schedule appointments directly with the services providers 110 without transferring the call or speaking directly to the services providers. Each services provider 110 has its own firewalls to separate each account. Each services provider can only search for data (e.g., member names and contact information) that has been entered into that particular service provider's system.

All schedules are provided by the services providers 110 and can be edited in “real time.” For purposes of this invention, “real time” data manipulation means that several entities (e.g., the services facilitator 101 and the services providers 110) can review and edit current information in the database without substantial delay. For example, a first user enters the information and the database is immediately updated so that the second user can then access the most up to date information. The second user cannot alter the data when the first user is updating it, but the second user immediately sees the change made by the first user and can then immediately manipulate the data itself. This reduces errors in the database 303 since data does not have to be reconciled or synchronized. It also saves time since current information is immediately available to everyone.

Any active scheduler has access to the Web-based system to update scheduling information and schedule appointments. For purposes of this invention, an “active scheduler” can be, for example, a services facilitator, a call center, or a services provider.

A unique feature of this system 300 is that it allows for obtaining eligibility information or pre-screening information from members 106. For purposes of this invention, “eligibility information” is defined as any information that allows for a determination to be made as to whether a person is eligible to receive a requested service (e.g., laser vision correction surgery). Such information may include, for example, physical conditions, allergies, diseases, and age. This pre-screening of members determines whether they are potential candidates for the particular health services. In the pre-screening process (described in more detail with respect to FIGS. 10-35 below), the call centers 310 preferably ask scripted, pre-set questions that determine whether the member 106 is a potential candidate for the requested service. This pre-screening saves the services providers 110 a significant amount of time and money by maximizing time spent on members who are strong candidates for the requested services. Pre-screening questions for laser vision correction surgery include, for example, whether the member is near-sighted or far-sighted, whether the member suffers from astigmatism, and whether the member has diabetes.

The Web-based system 300 also tracks completed procedures, cancellations, reasons for cancellations, outcomes, and other statistical data. For example, if the requested service is laser vision correction, the system 300 may track the type of laser and microkeratome and the medical drops used by each services provider. This information is stored in the database 303, and may be used by the services facilitator 101 to compile utilization reports based on, for example, physician, health plan, or surgical outcomes. In this latter example, the system 300 links the services facilitator to the services providers through a single surgical tracking, scheduling, and outcomes Web-based system. Thus, the Web-based system 300 allows services providers to increase their surgical volumes without increasing staff or overhead expenses. It also eliminates the cost of advertising for the services provider's office. These reasons, coupled with organization volume and general price compression, allow the services provider to lower prices for services to the organization's members.

The Web-based system 300 is designed using known Web-based computer programming languages, such as PHP, Java, or HTML. The database design, structure, communications links or connections to the central server 302, and the remote terminals 314 are known in the art and can be implemented by one of ordinary skill.

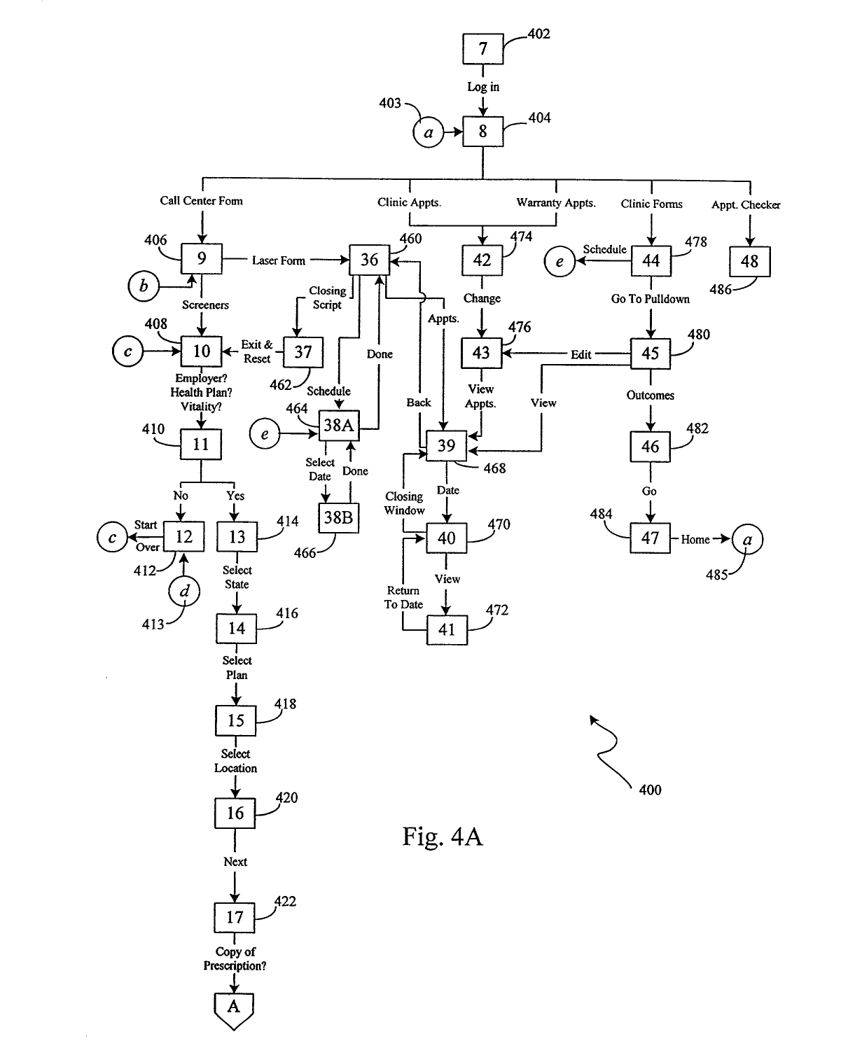

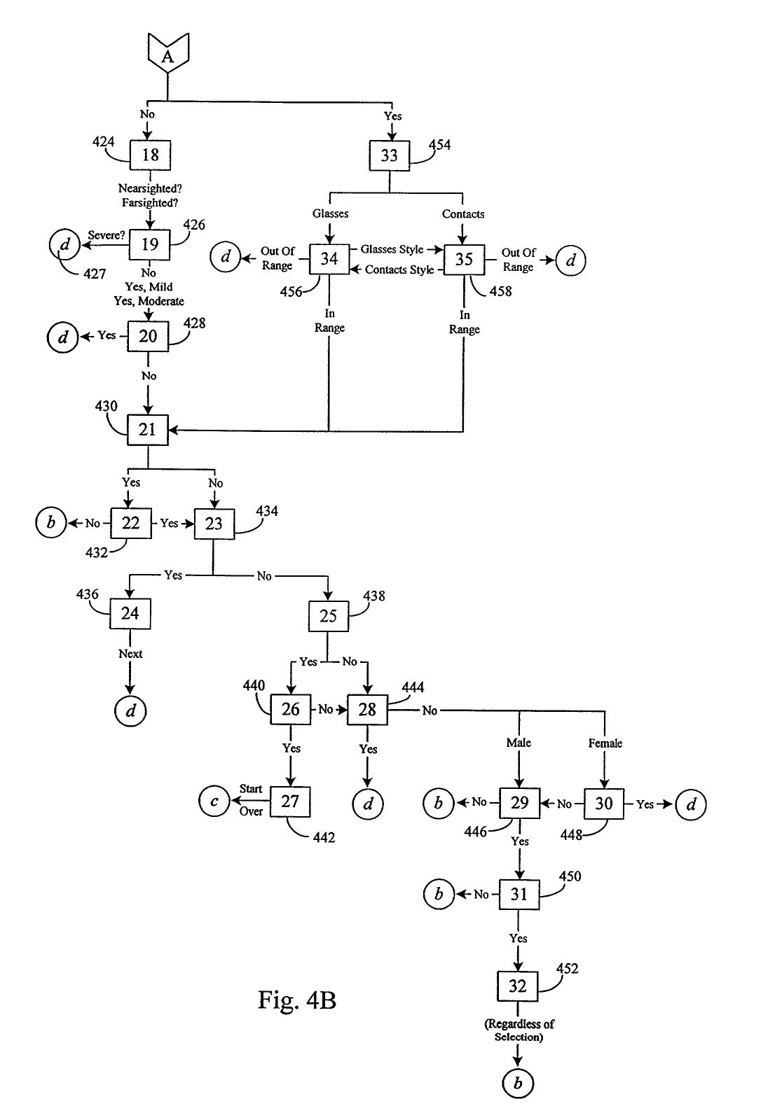

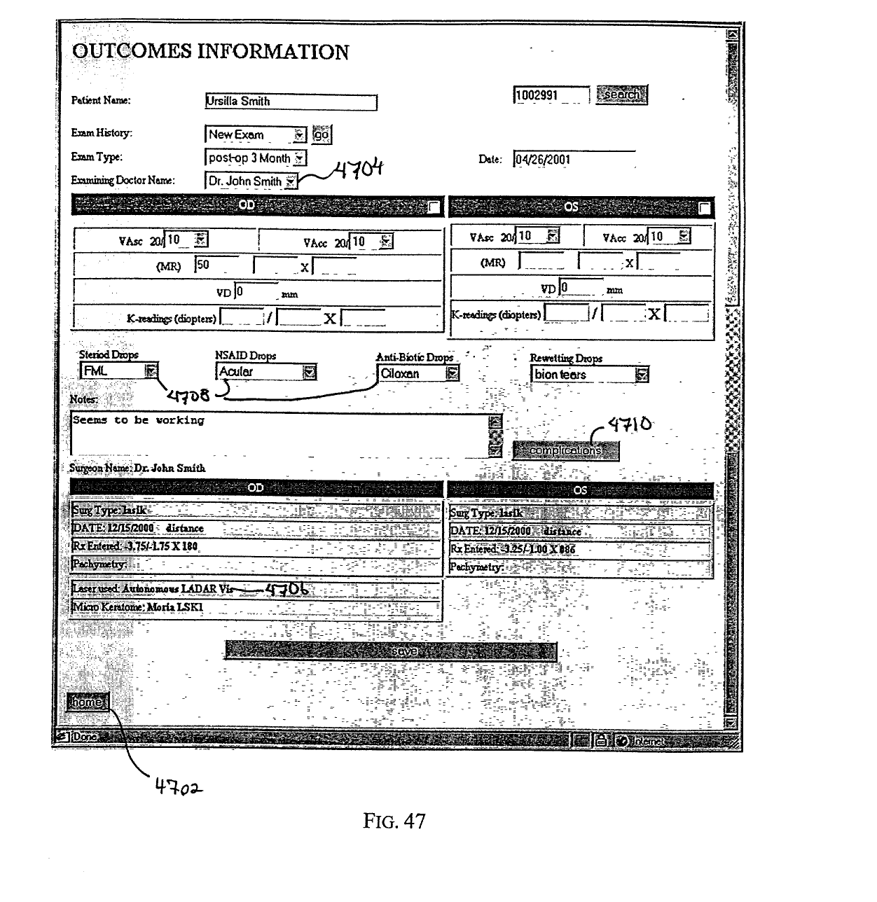

FIGS. 4A and 4B together comprise a screen-shot tree 400 that exemplifies the pre-screening, scheduling, and outcome tracking features of the Web-based system for laser vision correction services in accordance with one embodiment of the present invention. This figure outlines the Web-based system for the health services facilitator (including the customer service center) and the health services providers alike. FIGS. 7-48 are sample screen shots referenced within the screen-shot tree 400 of FIGS. 4A and 4B. For example, the top block 402 of screen shot tree 400 in FIG. 4A contains a “7” to refer to FIG. 7, which depicts a sample opening screen shot. Similarly, block 404 contains an “8” to refer to FIG. 8, which depicts another sample screen shot. The remaining screen shots of FIGS. 9-48 are similarly referred to by numbers within the square blocks of the screen shot tree 400. Characters in circles are jump or transfer references, which refer to previous figure references. For example, the circled letter “a” at 485 (FIG. 4A) represents a transfer to the circled letter “a” at 403 (also in FIG. 4A). In other words, if the screen shot depicted in FIG. 47 (see block 484 in FIG. 4A) is displayed, and if the “Home” button 4702 (FIG. 47) is selected, then the screen depicted in FIG. 9 (see block 404 in FIG. 4A) is displayed. The transfer or jump from the screen shot depicted in FIG. 47 to the screen shot depicted in FIG. 8 is represented by the arrow from block 484 to the circled letter “a” at 485, together with the circled letter “a” at 403 and the arrow from 403 to block 404. The text next to many of the connecting lines or arrows in the tree 400 provides additional information about, for example, an action by the particular active user, such as a services facilitator or a services provider, that results in the screen transition represented by the particular connecting line. These actions are often clicks on a particular button within the screen.

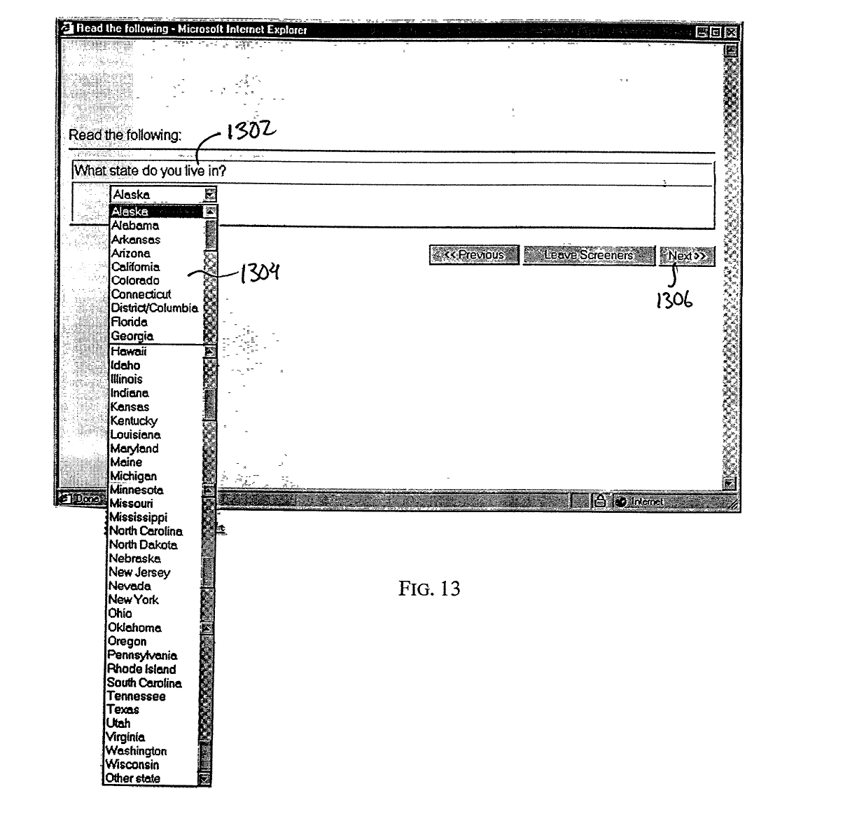

Throughout the description of FIGS. 4A and 4B, there are several recurring options that provide the same function throughout the Web-based system. For example, in FIG. 11 the user can select the “Previous” button 1102 or the “Next” button 1104. Such “Previous” and “Next” buttons allow the user to navigate through the Web-based system. For example, the “Previous” button 1102 takes the user back to the previous screen in the tree (in this example, the screen depicted in FIG. 10), while the “Next” button 1104 takes the user to the next screen in the tree (in this example, the screen depicted in FIG. 12) if the question asked in FIG. 11 is answered “No” and to the screen depicted in FIG. 13 if the question is answered “Yes”).

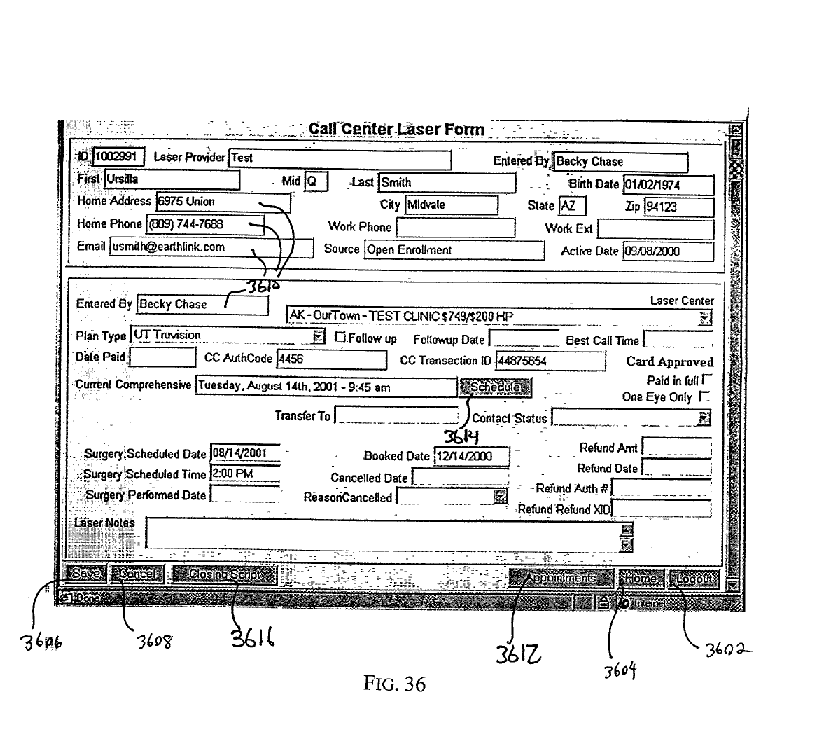

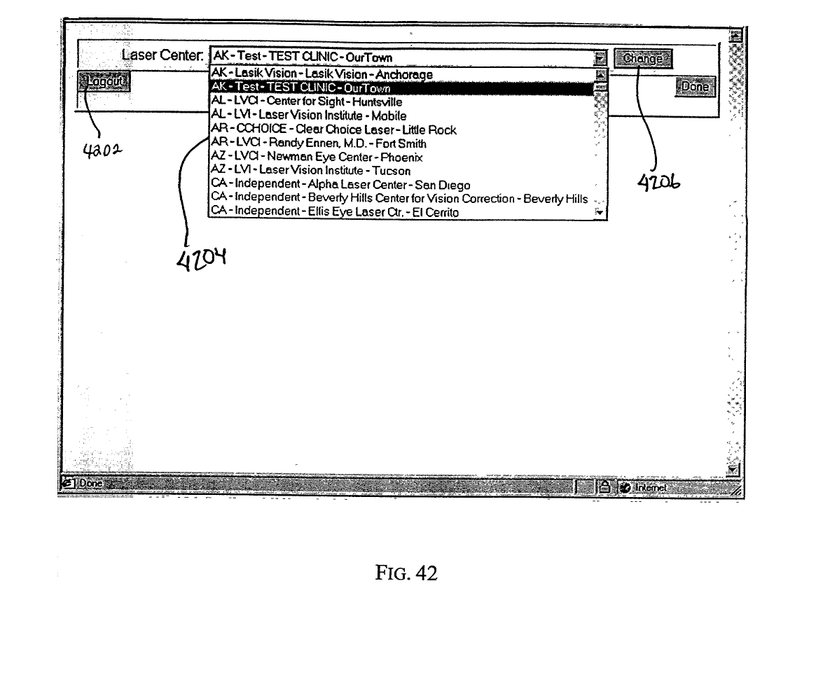

Another example is the “Logout” button (e.g., 802 in FIG. 8, 3602 in FIG. 36, and 4202 in FIG. 42). This button logs the user out of the system and the system logic returns the user to the screen depicted in FIG. 7.

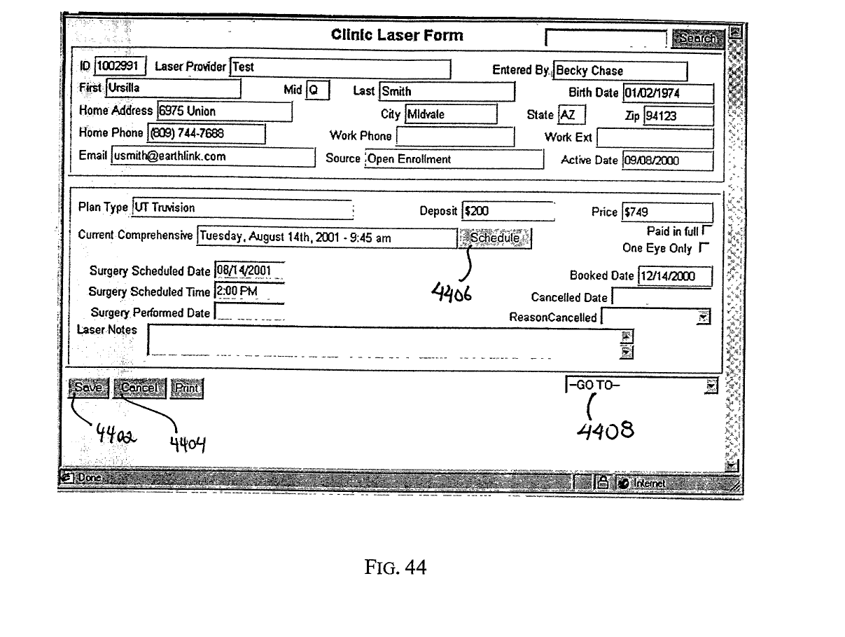

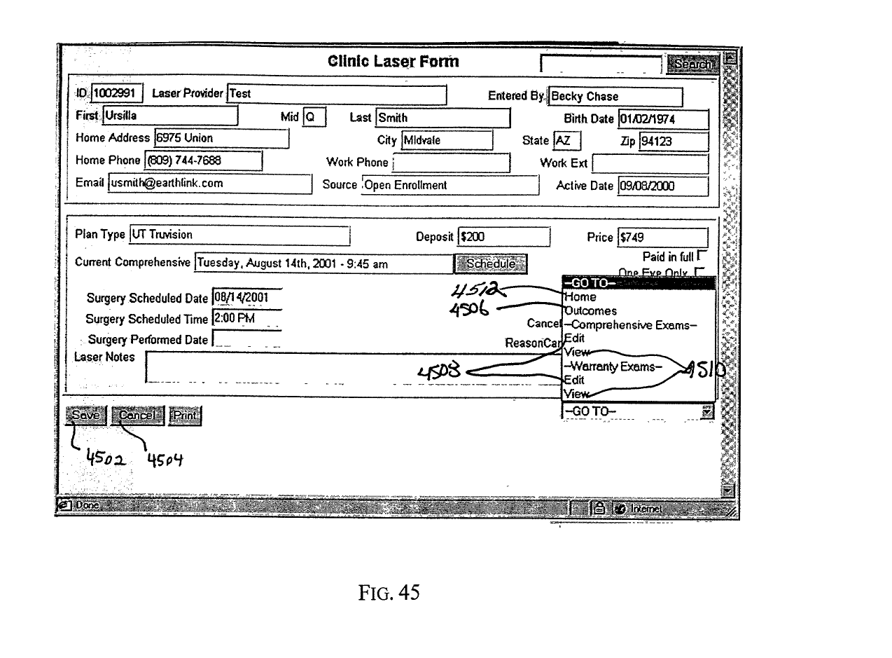

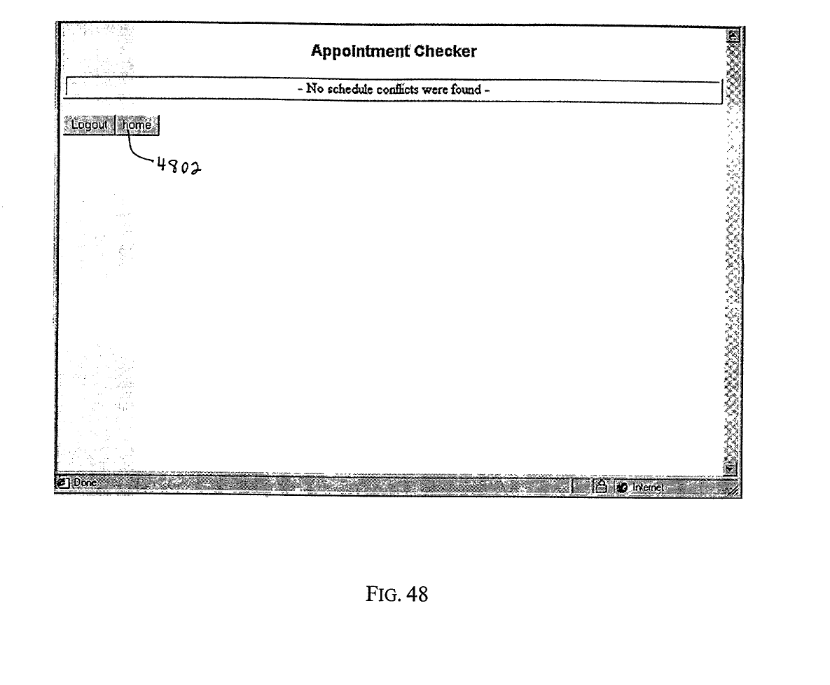

Another such example is the “Home” button (e.g., 3604 in FIG. 36, 4702 in FIG. 47, and 4802 in FIG. 48). This button takes the active scheduler back to the screen depicted in FIG. 8. Selection of the “Home” entry 4512 (FIG. 45) in the “Go To” pull-down menu 4408 (FIG. 44) also takes the active schedules back to the screen depicted in FIG. 8. The “Save” button (e.g., 902 in FIG. 9, 3606 in FIG. 36, 4402 in FIG. 44, and 4502 in FIG. 45) saves the data entered into the particular form into the database, and the “Cancel” button (e.g., 904 in FIG. 9, 3608 in FIG. 36, 4404 in FIG. 44, and 4504 in FIG. 45) clears the data entered into the particular form.

Similarly, the “Delete” button (e.g., 906 in FIG. 9) deletes all the information pertaining to a particular member that was previously entered in the form shown in FIG. 9.

Referring back to FIG. 4A, initially, at block 402, an active scheduler, such as a services facilitator (including a customer service center) or a services provider, accesses the health services facilitator's web-site through the Internet and is prompted to logon at an Agent Login screen (see FIG. 7). In advance of attempting to login, the active scheduler has preferably been assigned an “Agent ID” and “Password” by the health services facilitator. The Agent ID is entered into text box 702, and the Password is entered into text box 704. The Agent ID and the Password determine the screens within the system to which the particular logged-in active scheduler has access. After the active scheduler enters its Agent ID and Password and clicks on the “Logon” button 706, a user menu is preferably displayed at block 404 of FIG. 4A.

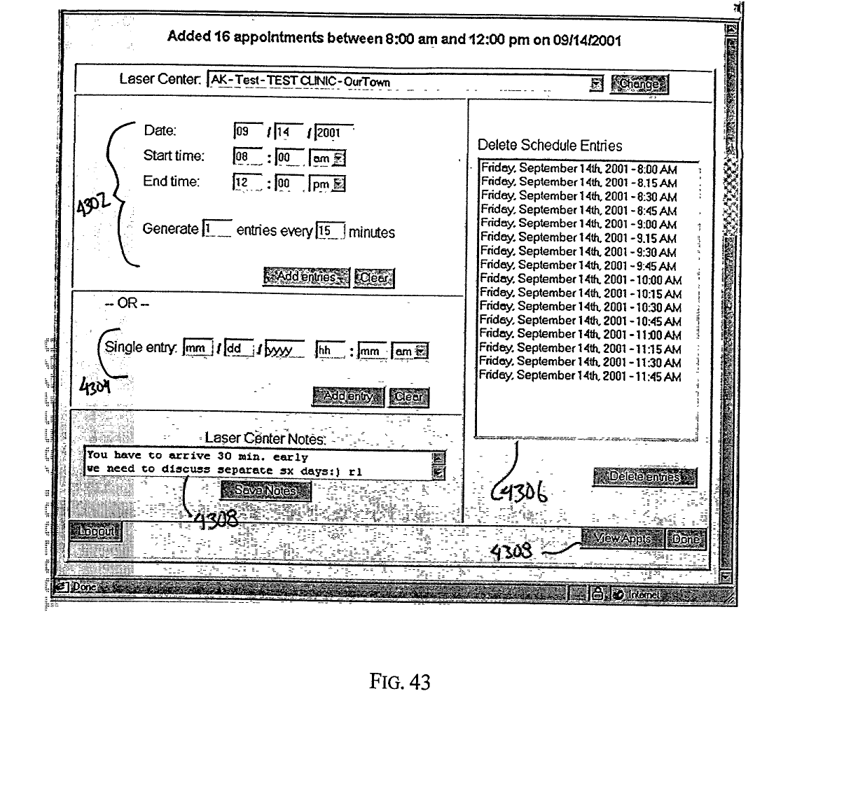

To show the structure and logic of the entire Web-based system, the flow diagram depicted in FIGS. 4A and 4B assumes that a “Superuser” has logged in at block 402. This Superuser is a user that has the ability to act as any active scheduler, such as a services facilitator (including a customer service center) and a services provider. After the Superuser logs in, at block 404, the system logic causes a screen like that depicted in FIG. 8 to be displayed. This Superuser Menu in FIG. 8 is not generally seen by the health services facilitator (including the customer service centers) and the health services providers. For example, an active scheduler from the customer service center typically cannot add appoints for a laser center (see FIGS. 42 and 43 and corresponding blocks 474 and 476 on FIG. 4A).

With respect to the Superuser example, clicking on the various buttons 804-812 in FIG. 8 causes the system logic to display particular screens within the Web-based system. For example, clicking on the “Call Center Form” button 804 causes the system logic to display the screen depicted in FIG. 9. This is represented by blocks 404 and 406 in FIG. 4A. Clicking on the “Clinic Appointments” or “Warranty Appointments” buttons 806 and 808, respectively, causes the system logic to display the screen depicted in FIG. 42 (see block 474 of FIG. 4A). Clicking on the “Clinic Forms” button 810 causes the system logic to display the screen depicted in FIG. 44 (see block 478 of FIG. 4A). The Web-based system is preferably set up to automatically prevent two schedulers from double-booking the same appointment. Clicking on the “Appointment Checker” button 812, causes the system logic to verify that no schedule conflicts in fact exist and typically results in display of the screen depicted in FIG. 48 (see block 486 of FIG. 4A). Clicking on the “Logout” button 802 logs the active scheduler out of the system and causes the system logic to display a screen like that depicted in FIG. 7, as previously explained. The “CC Processing” button 814 in FIG. 8 relates to credit card processing. If “CC Processing” is “On,” credit card processing runs while a patient is on the telephone, and a receipt for any changes may be sent electronically.

In the event the user is a health services facilitator or a customer service center (including in-house call centers or overflow call centers), the system logic flows generally from block 404 of FIG. 4A to 406 and accordingly down through blocks 408-452 (FIGS. 9-35) of FIGS. 4A and 4B. Upon selection of the “Call Center Form” button 804 (FIG. 8), the system logic displays at box 406 the “Insured Member Form” as shown in FIG. 9. This form allows the health services facilitator or customer service center o enter new information about a member into the various text boxes 908 or to access previously entered information from the database in response to a communication from a member by entering identifying information such as the member's social security number into the search text box 910 and clicking on the Search button 916.

Referring to FIGS. 4A, 4B, and 9, upon selection of the “Screeners” button 914 (FIG. 9), the system logic begins the pre-screening questions (see blocks 408-452 in FIGS. 4A and 4B, corresponding to FIGS. 10-35) by displaying at block 408 the screen depicted in FIG. 10. These pre-screening questions are posed to a member who has contacted the active scheduler through a communications system, preferably a telephone. The active scheduler preferably reads each question to the member, then steps through the questions shown in FIGS. 10-32, proceeding through the Web-based system depending on the member's response. The pre-screening question responses are entered into the Web-based system by the active scheduler, and this information is saved within the database.

The first of the pre-screening questions is shown in FIG. 10 (see block 408 of FIG. 4A). The services facilitator preferably selects an option from the pull-down box 1002 and then selects the “Next” button 1004 which causes the system logic to display the screen depicted in FIG. 11 (see block 410 of FIG. 4A). At any point during the pre-screening questions, the active scheduler may decide to exit the pre-screening process by selecting a “Leave Screeners” button (e.g., 1006 in FIG. 10, 1110 in FIG. 11, and similar buttons on FIGS. 12-35). If an active scheduler selects such a “Leave Screeners” button, the system logic displays the screen shot depicted in FIG. 9 (see block 406 of FIG. 4A). To avoid needlessly complicating FIGS. 4A and 4B, the “Leave Screeners” paths back to block 406 have been left these figures. If the active scheduler has selected the “Next” button 1004 (FIG. 10) and has been presented with the screen depicted in FIG. 11, the active scheduler next reads the query 1106 (FIG. 11) and selects the appropriate response in the pull-down box 1108.

If the query 1106 results in a “No” answer, the active scheduler properly selects this response in the pull-down box 1108 and then selects the “ext” button 1104. This causes the system logic to display the screen depicted in FIG. 12 (see block 412 in FIG. 4A). At this point, the pre-screening questions end, and the active scheduler can select the “Start Over” button 1202, which causes the system logic to display the initial pre-screening question depicted in FIG. 10, or the active scheduler can select the “Leave Screeners” button 1204, which, as just explained, causes the system logic to display the screen depicted in FIG. 9.

If the query 1106 (FIG. 11) results in a “Yes” answer, the active scheduler selects this response in the pull-down box 1108 and selects the “Next” button 1104. This causes the system logic to display the screen depicted in FIG. 13 (see block 414 in FIG. 4A).

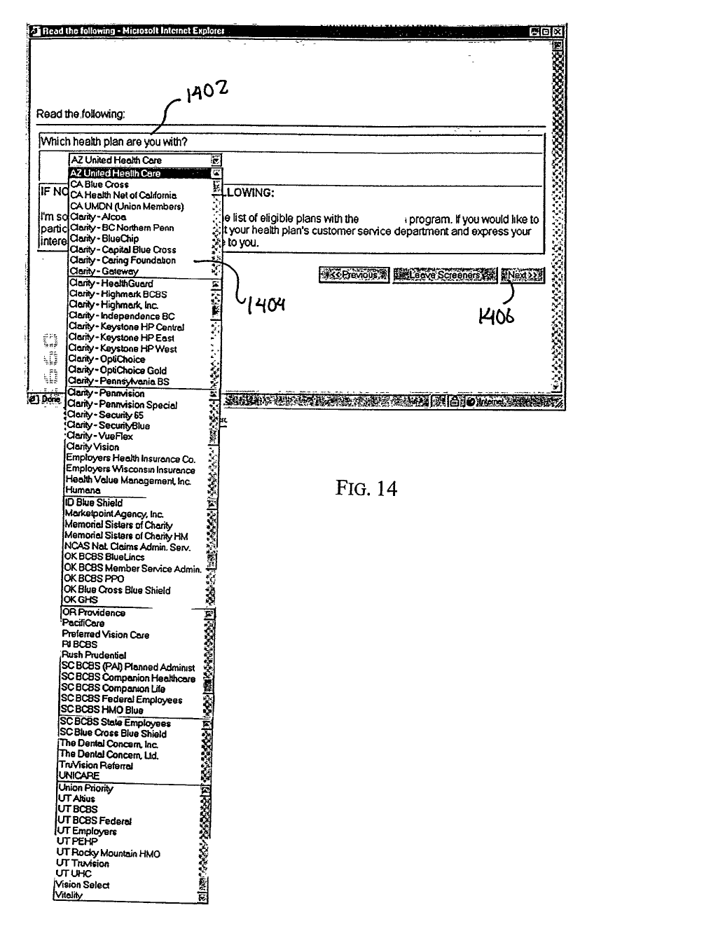

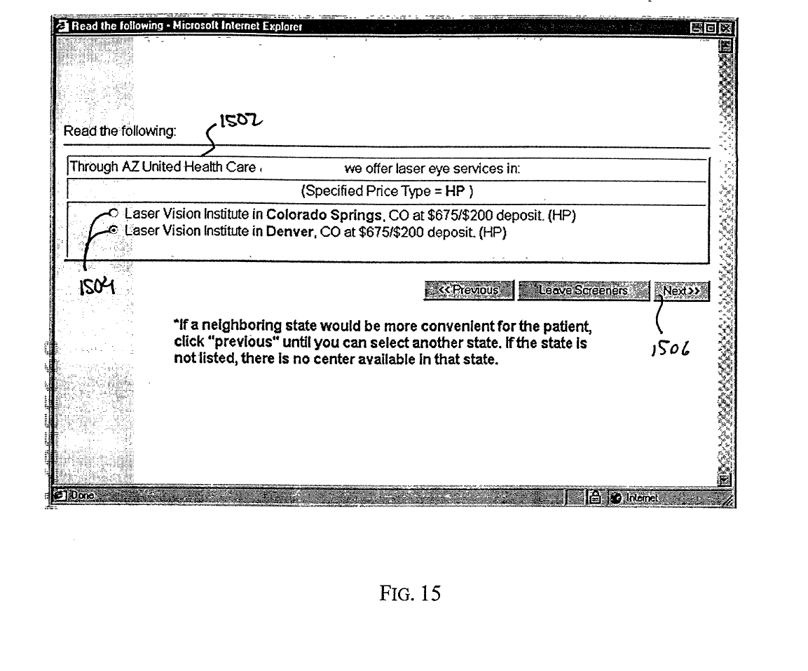

The active scheduler is next prompted to read the query 1302 in FIG. 13 and select the appropriate answer in the pull-down box 1304. Once the appropriate response is selected from the pull-down box 1304, the active scheduler selects the “Next” button 1306, which causes the system logic to display the screen depicted in FIG. 14 (see block 416 in FIG. 4A).

Within FIG. 14, the active scheduler is next prompted to read the query 1402 to the member and then to select the appropriate response in the pull-down box 1404. Preferably the health plan information displayed within the pull-down box 1404 is related to the state information selected by the active scheduler in the pull-down box 1304 of FIG. 13. Once this health plan information is selected, the active scheduler selects the “Next” button 1406, which causes the system logic to display the screen depicted in FIG. 15 (see block 418 of FIG. 4A).

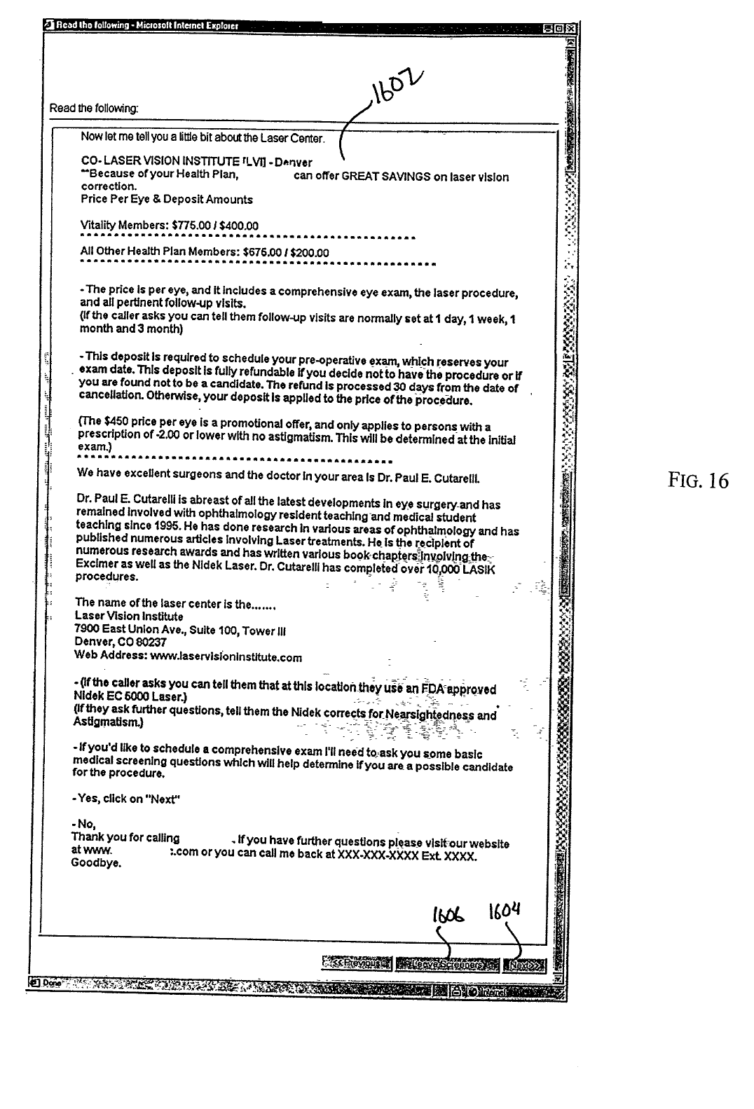

The active scheduler is next prompted to read the information 1502 in FIG. 15 to the member and then to indicate the appropriate response by selecting the corresponding radio button 1504. The information displayed within this form is preferably based on the information selected by the active scheduler in pull-down box 1304 of FIG. 13. Once the appropriate response from the member is indicated on FIG. 15, the active scheduler selects the “Next” button 1506, which causes the system logic to display the screen depicted in FIG. 16 (see block 420 of FIG. 4A).

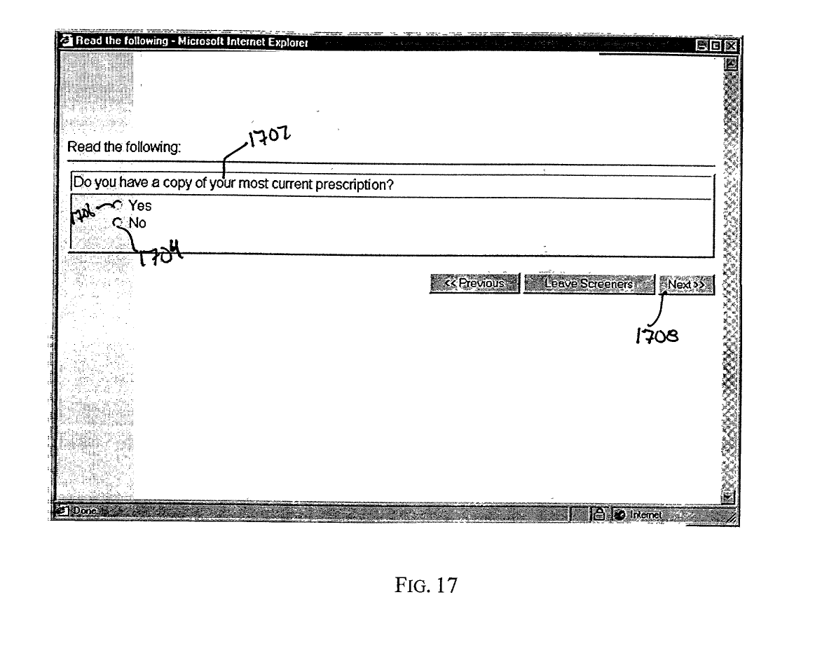

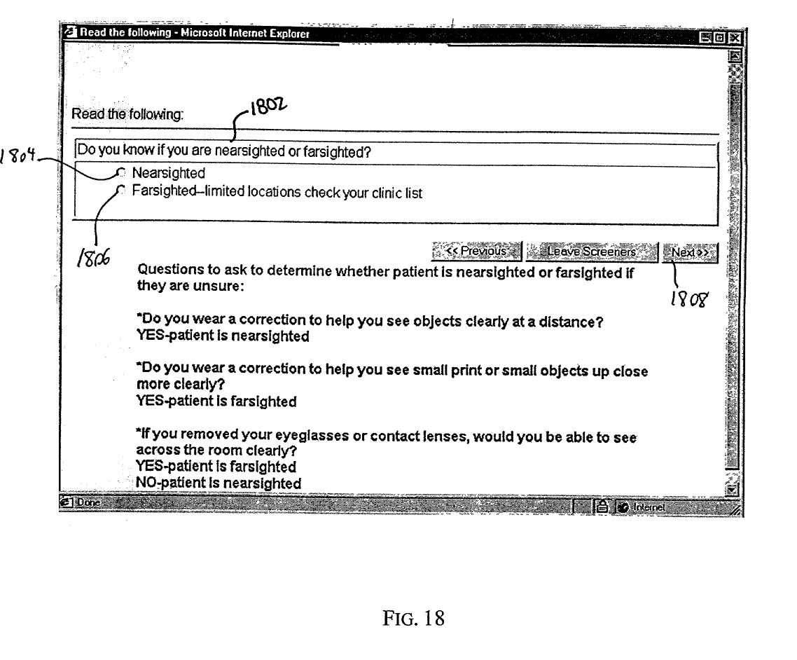

The active scheduler is next prompted to read the information 1602 depicted in FIG. 16. If the response from the member is “Yes” (i.e., the member would like to continue with the pre-screening process), the active scheduler selects the “Next” button 1604, which causes the system logic to display the screen shot depicted in FIG. 17 (see block 422 of FIG. 4A). If the response from the member is “No,” the active scheduler selects the “Leave Screeners” button 1606, which, as discussed above, cause the system logic to display the screen depicted in FIG. 9.

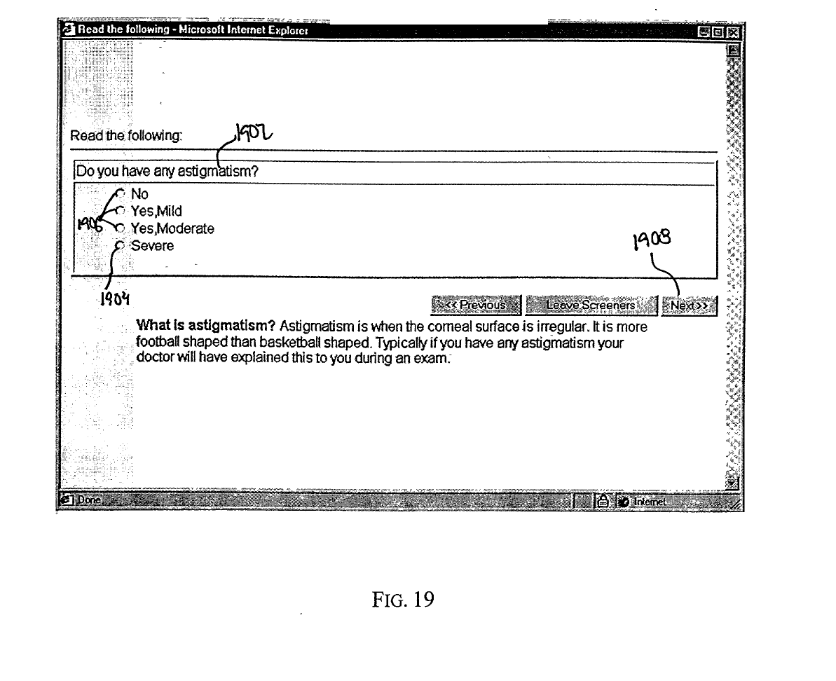

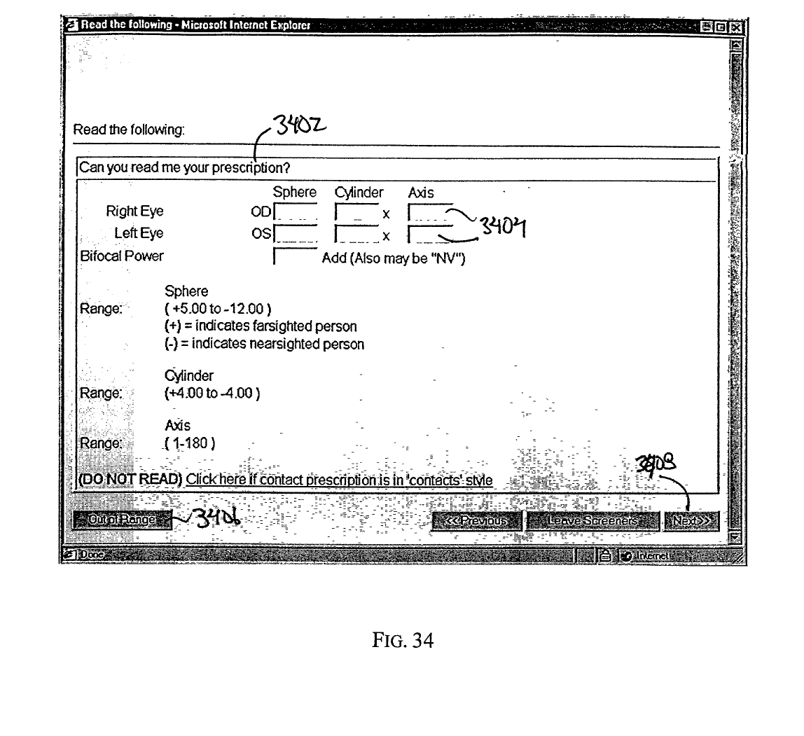

If the pre-screening process continues, the active scheduler is next prompted to read the query 1702 in FIG. 17. The active scheduler selects the appropriate radio button (1704 or 1706) depending on the response from the member. If the response from the member is “No,” radio button 1704 is selected and clicking on the “Next” button 1708 causes the system logic to display the screen depicted in FIG. 18 (see block 424 of FIG. 4B). If the response from the member is “Yes,” radio button 1706 is selected and clicking on the “Next” button 1708 causes the system logic to display the screen depicted in FIG. 33 (see block 454 of FIG. 4B).

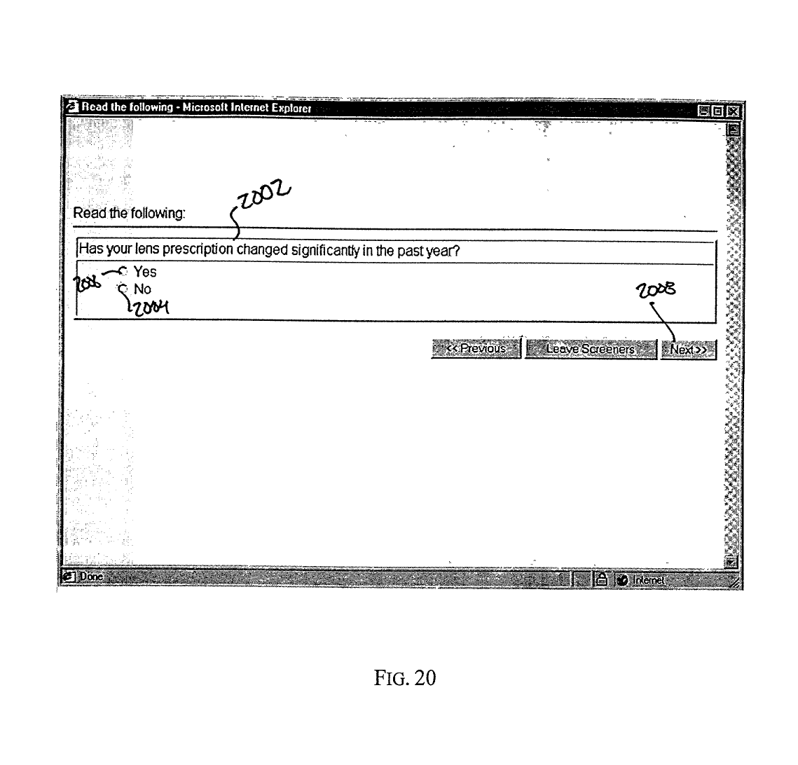

In the case that the answer to query 1702 is “No,” and the system logic causes FIG. 18 to be displayed, the active scheduler is prompted to read the query 1802. The facilitator selects the appropriate radio button (1804 or 1806) depending on the response from the member. No matter which response (1804 or 1806) is selected, upon subsequent selection of the “Next” button 1808, the system logic displays the screen shot depicted in FIG. 19 (see block 426 of FIG. 4B).

While viewing the screen shot depicted in FIG. 19, the active scheduler is next prompted to read the query 1902. The active scheduler then selects the appropriate radio button (1904 or 1906) depending on the response from the member. If the response is that the member has severe astigmatism (i.e., the radio button 1904 labeled as “Severe” is selected) then subsequent selection of the “Next” button 1908 causes the system logic to display the screen depicted in FIG. 12 (see block 412 of FIG. 4A). This is represented in FIGS. 4A and 4B by the circled letter “d” transfer references 427 (FIG. 4B) and 413 (FIG. 4A). If the response is any of the other responses listed in FIG. 19, the active scheduler selects the appropriate radio button 1906 and then selects the “Next” button 1908, which causes the system logic to display the screen depicted in FIG. 20 (see block 428 in FIG. 4B).

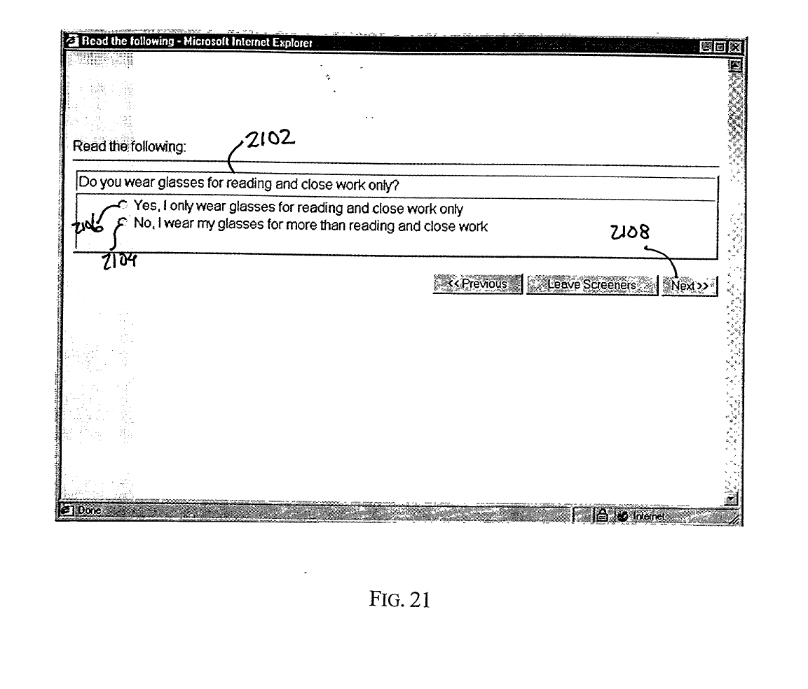

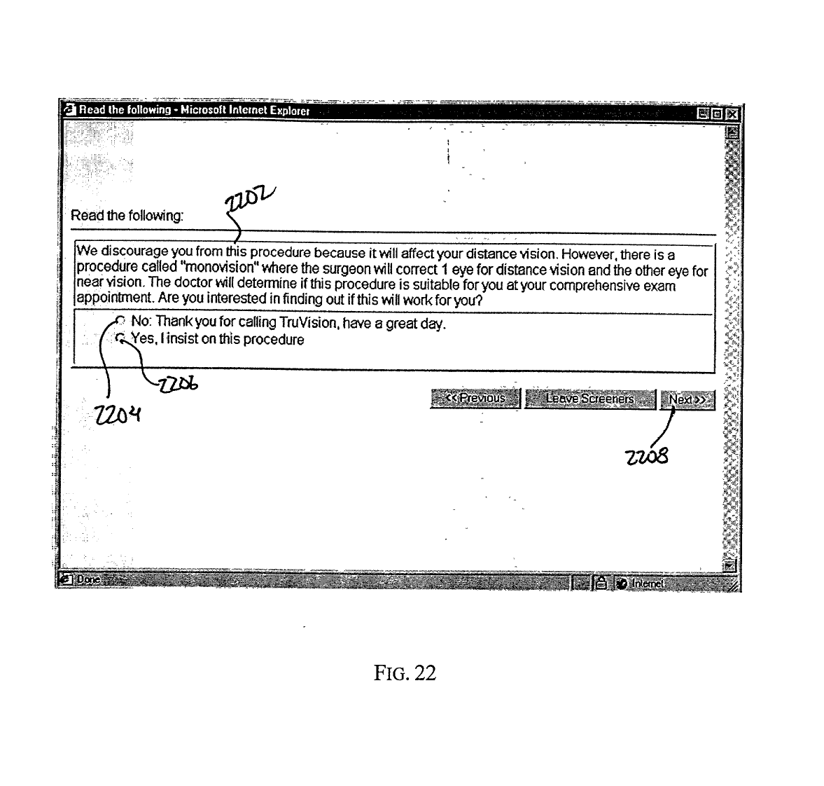

The active scheduler is next prompted to read the query 2002. The active scheduler again selects the appropriate radio button (2004 or 2006) based on the answer from the member. If the answer is “No,” selection of the radio button 2004 and then the “Next” button 2008 causes the system logic to display the screen depicted in FIG. 21 (see block 430 of FIG. 4B). If the answer is “Yes,” selection of the radio button 2006 and then the “Next” button 2008 causes the system logic to display the screen depicted in FIG. 12 (see block 412 of FIG. 4A).

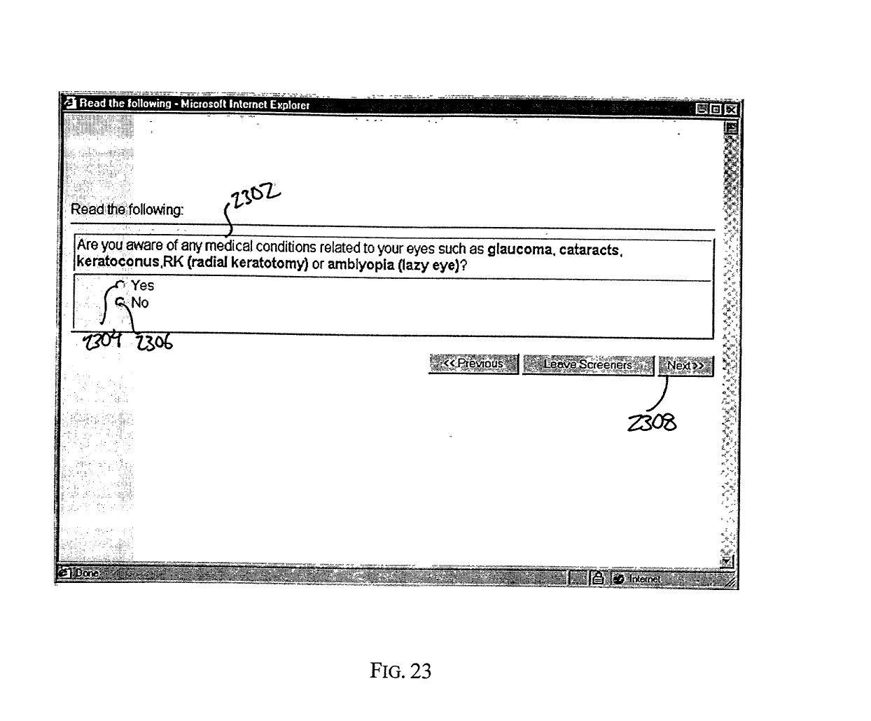

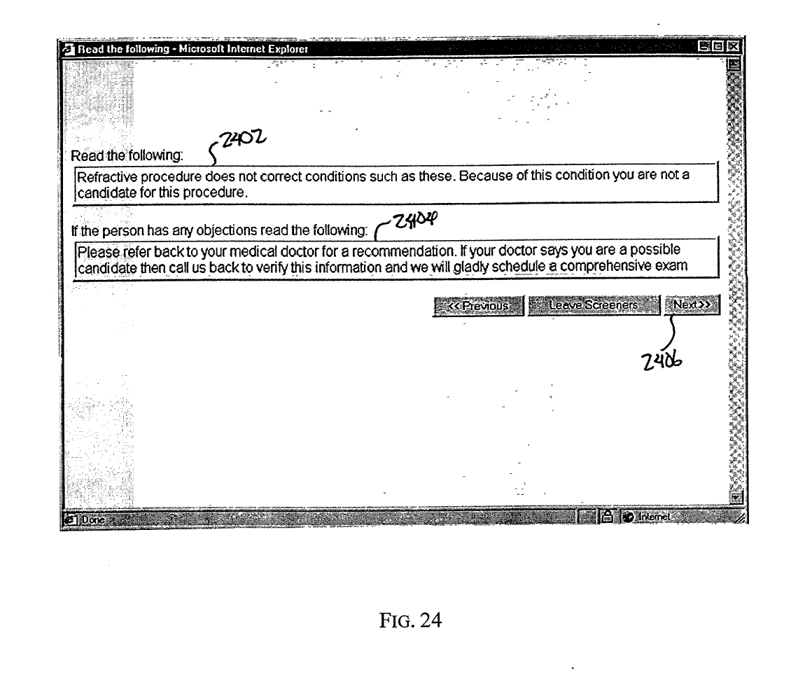

In the case that the answer to query 2002 is “No,” and the system logic causes the screen shot depicted in FIG. 21 to be displayed, the active scheduler is prompted to read the query 2102. The active scheduler again selects the appropriate radio button (2104 or 2106) based on the answer from the member. If the answer is “No,” selection of the radio button 2104 and then the “Next” button 2108 causes the system logic to display the screen depicted in FIG. 23 (see block 434 of FIG. 4B). If the answer is “Yes,” selection of the appropriate radio button 2106 and then the “Next” button 2108 causes the system logic to display the screen depicted in FIG. 22 (see block 432 of FIG. 4B).

In the case that the answer to query 2102 is “Yes” and the system logic accordingly displays the screen shot depicted in FIG. 22, the active scheduler is prompted to read query 2202. If the answer to the query 2202 is “No” the active scheduler selects the appropriate radio button 2204 and then the “Next” button 2208. This causes the system logic to display the screen depicted in FIG. 9 (see block 406 of FIG. 4A). If the answer to the query 2202 is “Yes” the facilitator selects the appropriate radio button 2206 and then the “Next” button 2208. This causes the system logic to display the screen depicted in FIG. 23 (see block 434 of FIG. 4B).

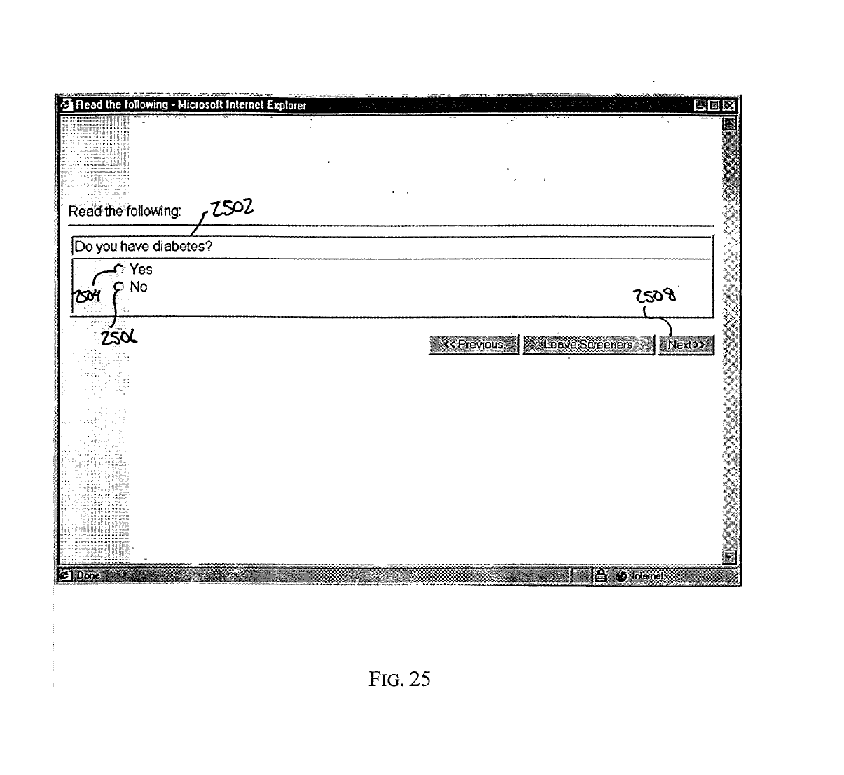

If pre-screening continues, the screen shot depicted in FIG. 23 prompts the active scheduler to read query 2302. Once again, the active scheduler selects the appropriate radio button (2304 or 2306) based on the answer from the member, “Yes” 2304 or “No” 2306, and then the “Next” button 2308. If the answer to the query 2302 is “Yes,” the system logic next displays the screen depicted in FIG. 24 (see block 436 of FIG. 4B). If the answer to the query is “No,” the system logic next displays the screen depicted in FIG. 25 (see block 438 of FIG. 4B).

In the case that the answer to query 2302 is “Yes” and the system logic displays the screen depicted in FIG. 24, the active scheduler is next prompted to ready the information at 2402 (FIG. 24) and, if the member has an objection to this information 2402, the active scheduler is instructed to read the information at 2404 . The active scheduler then selects the “Next” button 2406, which causes the system logic to display the screen depicted in FIG. 12 (see block 412 of FIG. 4A).

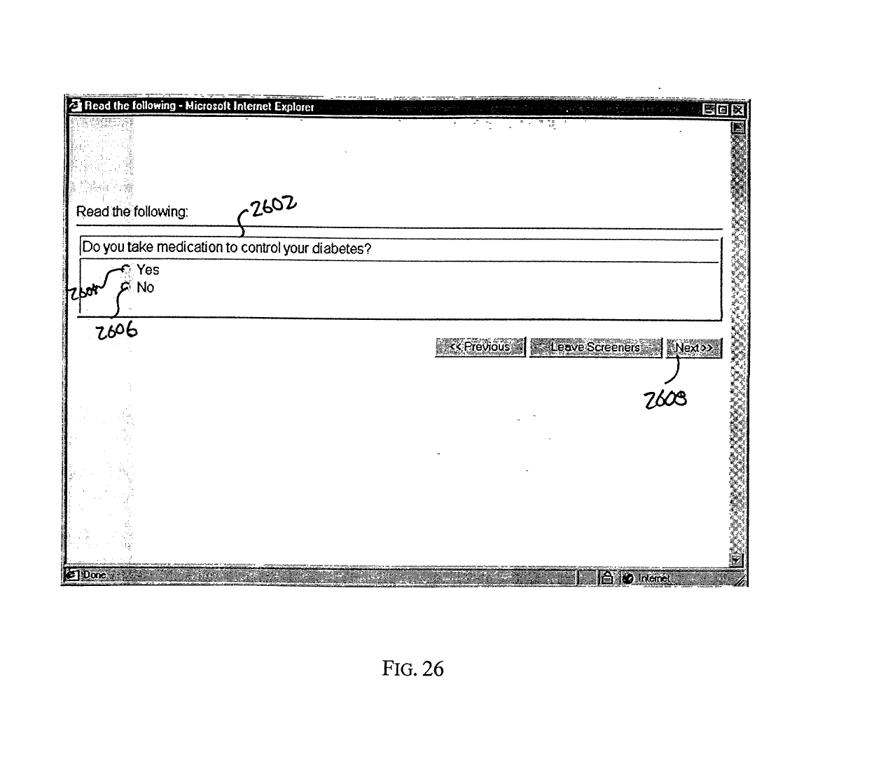

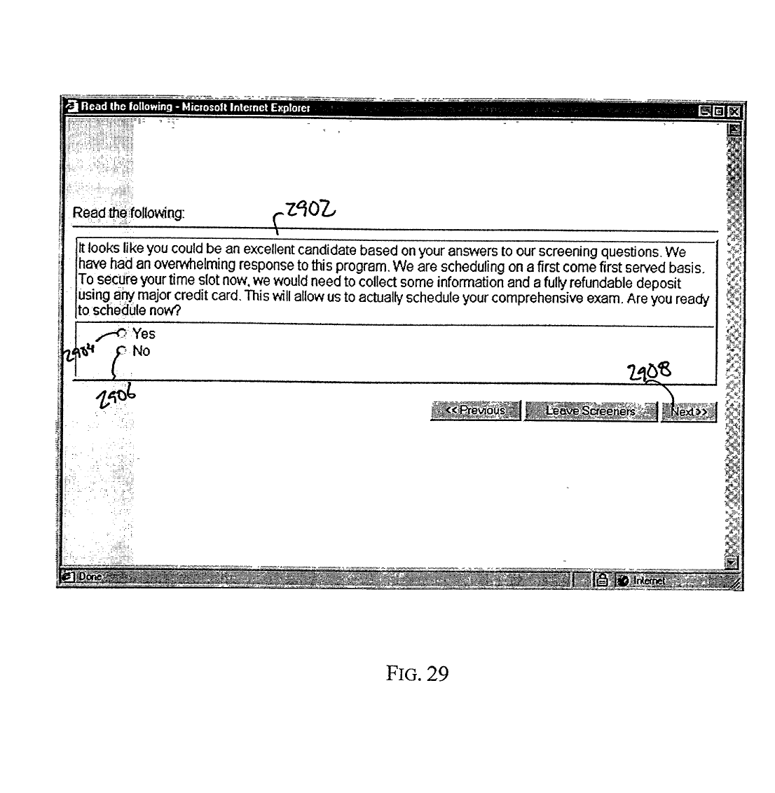

In the case that the answer to query 2302 is “No” and the system logic displays the screen depicted in FIG. 25, the active scheduler is next prompted to read query 2502. If the answer to the query is “Yes,” the active scheduler selects the radio button 2504, then selects the “Next” button 2508, and the system logic then displays the screen depicted in FIG. 26 (see block 440 of FIG. 4B). If the answer to the query 2502 is “No,” the active scheduler selects the radio button 2506, then selects the “Next” button 2508 and the system logic then displays the screen depicted in FIG. 28 (see block 444 of FIG. 4B).

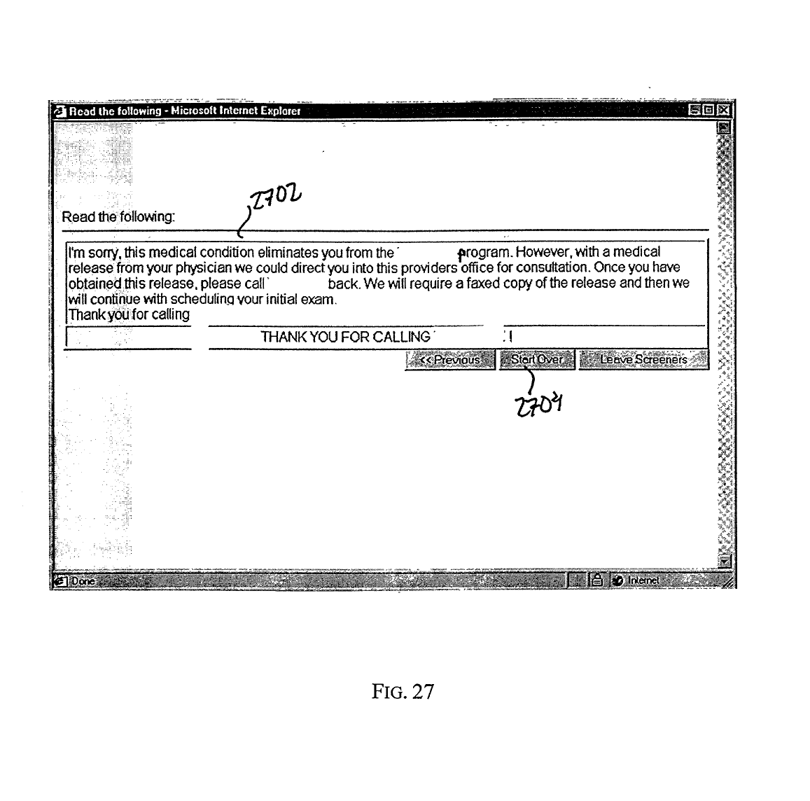

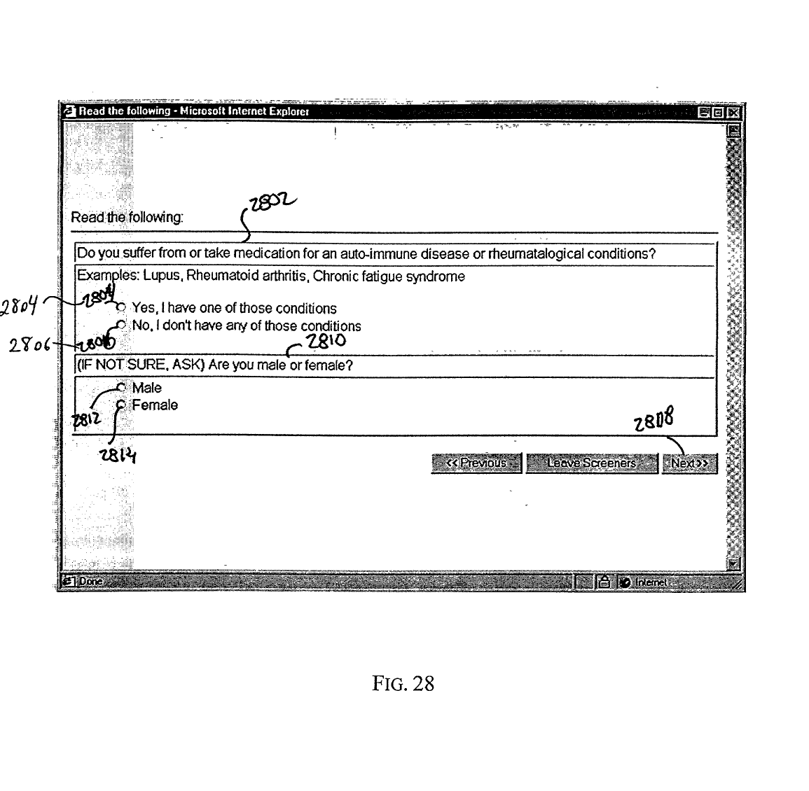

Referring to FIG. 26, the active scheduler is prompted to read query 2602. If the answer to the query is “Yes,” the facilitator selects the radio button 2604, then selects the “Next” button 2608, and the system logic then displays the screen depicted in FIG. 27 (see block 442 of FIG. 4B). If the answer to the query 2602 is “No,” the active scheduler selects the radio button 2606, then selects the “Next” button 2608, and the system logic then displays the screen depicted in FIG. 28 (see block 444 of FIG. 4B).

Referring to FIG. 27, the active scheduler is prompted to read the information at 2702 and is provided with an option to select a “Start Over” button 2704, which causes the system logic to display the screen depicted in FIG. 10 (see block 408 of FIG. 4A) which starts the pre-screening process anew.

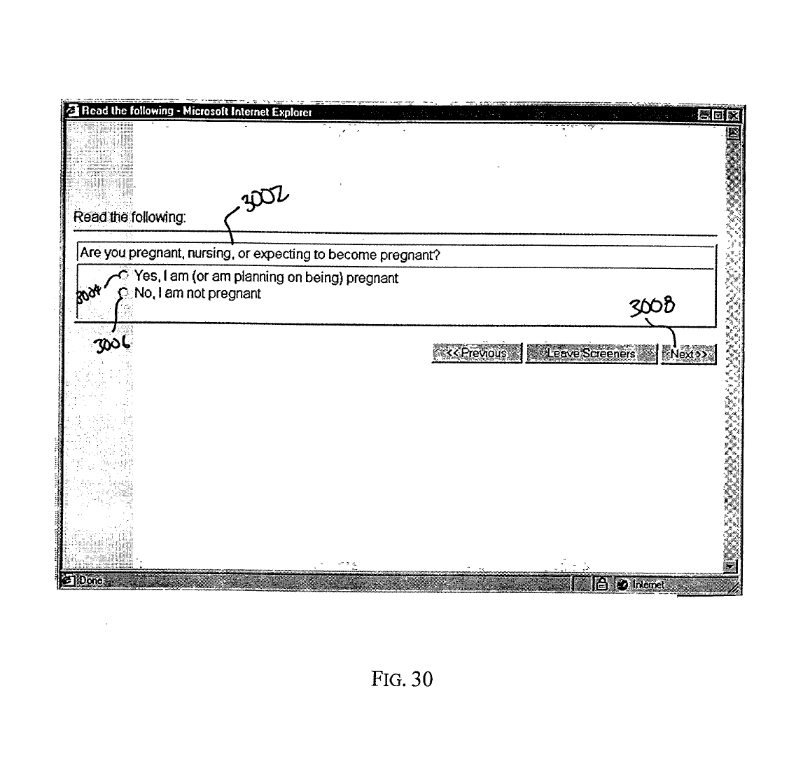

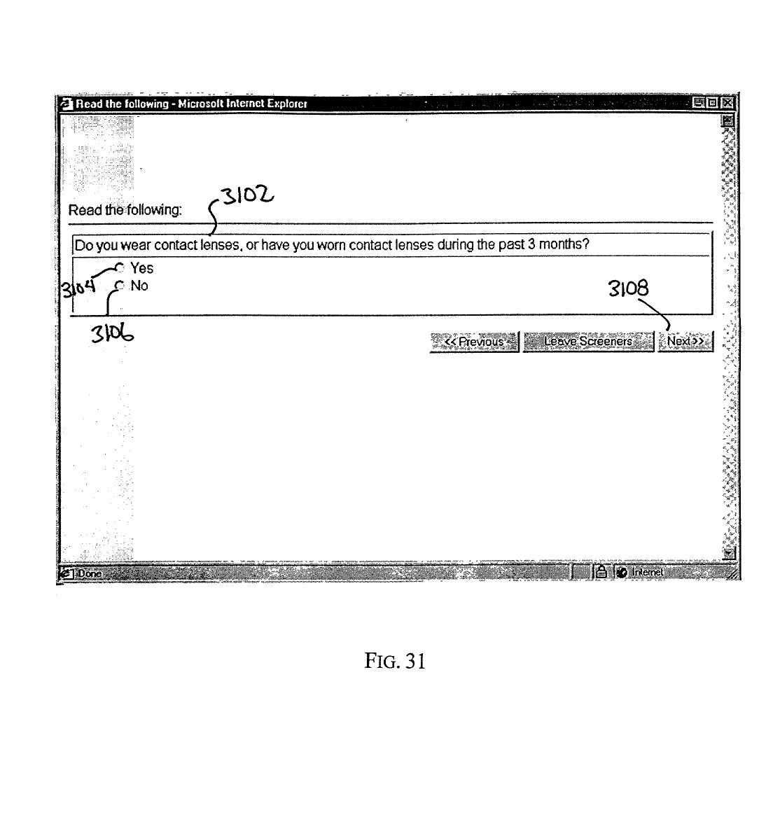

Referring now to FIG. 28, the active scheduler is prompted to read query 2802 to the member. If the answer to the query is “Yes,” the active scheduler selects the radio button 2804, then selects the “Next” button 2808, and the system logic then displays the screen depicted in FIG. 12 (see block 412 of FIG. 4A). If the answer to the query 2802 is “No,” the active scheduler selects the radio button 2806, then selects the “Next” button 2808, and the system logic then prompts the active scheduler to read the second query 2810. If the answer to the second query is “Male,” the active scheduler selects the radio button 2812 and then the “Next” button 2808, which causes the system logic to display the screen depicted in FIG. 29 (see block 446 of FIG. 4B). If the answer to the second query 2810 is “Female,” the active scheduler selects the radio button 2814 and then the “Next” button 2808, which causes the system logic to display the screen depicted in FIG. 30 (see block 448 of FIG. 4B).

In the case of the system logic displaying FIG. 30 (female member), the active scheduler is prompted to read query 3002. If the answer to the query is “Yes,” the active scheduler selects the radio button 3004, then selects the “Next” button 3008, and the system logic then displays the screen shot depicted in FIG. 12 (see block 412 of FIG. 4A). If the answer to the query 3002 is “No,” the active scheduler selects the radio button 3006, then selects the “Next” button 3008, and the system logic displays the screen shot depicted in FIG. 29.

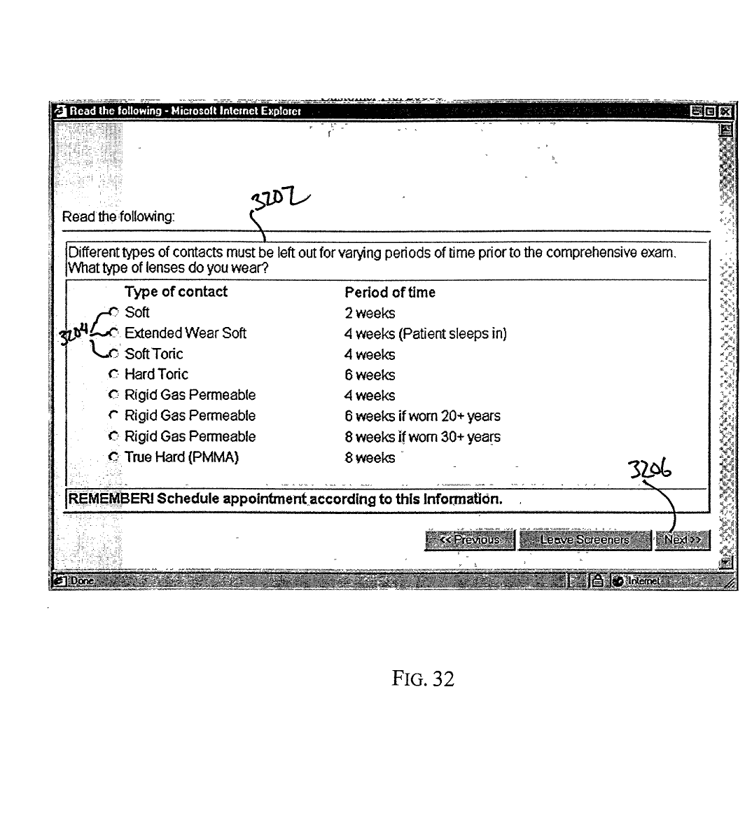

In the case of the system logic displaying the screen shot depicted in FIG. 29, the active scheduler is prompted to read query 2902. If the answer to the query 2902 is “Yes,” the active scheduler selects the radio button 2904, then selects the “Next” button 2908, and the system logic then displays the screen depicted in FIG. 31 (see block 450 of FIG. 4B). If the answer to the query is “No,” the active scheduler selects the radio button 2906, then selects the “Next” button 2908, and the system logic displays the screen depicted in FIG. 9 (see block 406 of FIG. 4A).

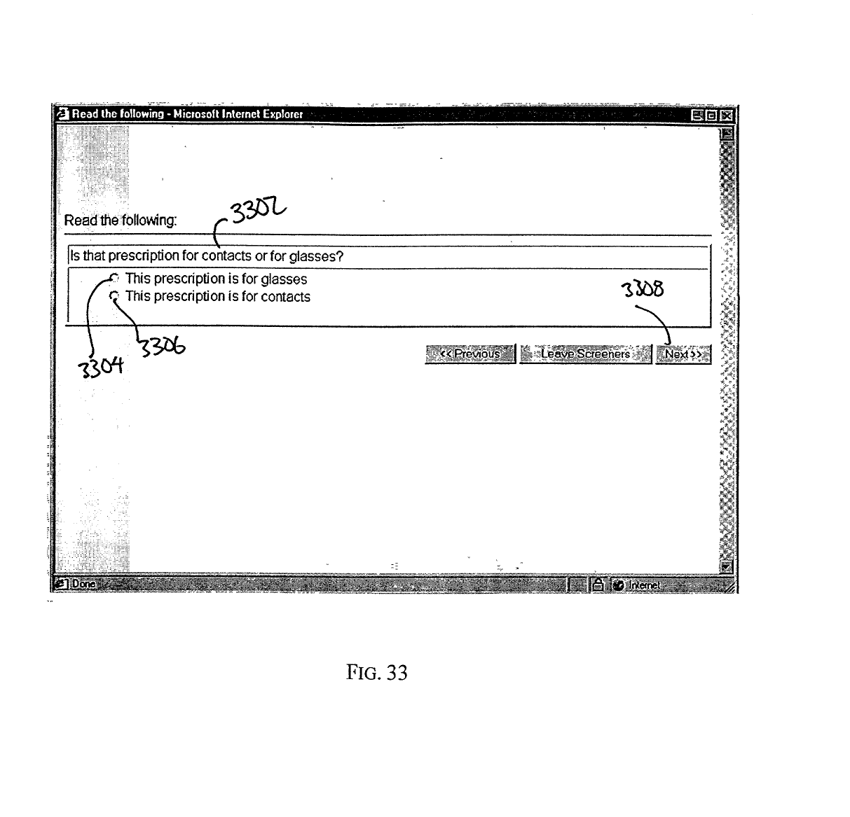

If pre-screening continues, the screen shot depicted in FIG. 31 prompts the active scheduler to read query 3102. If the answer to the query 3102 is “Yes,” the active scheduler selects the radio button 3104, then selects the “Next” button 3108, and the system logic then displays the screen depicted in FIG. 32 (see block 452 of FIG. 4B). If the answer to the query 3102 is “No,” the active scheduler selects the radio button 3106, then selects the “Next” button 3108, and the system logic displays the screen depicted in FIG. 9 (see block 406 of FIG. 4A). From this point, the screen shot depicted in FIG. 9 is displayed, and the active scheduler can then enter the appropriate customer information into the form depicted as FIG. 9 and proceed with scheduling appointments, which will be discussed in more detail below.

Referring to FIG. 32, where it has been determined that the member wears contact lenses or has recently worn contact lenses, the active scheduler is next prompted to read query 3202. Depending on the response from the member, the active scheduler selects the radio button 3204 and then selects the “Next” button 3206, which cause the system logic to display the screen depicted in FIG. 9. From this point, the active scheduler can then enter the appropriate customer information into the form depicted as FIG. 9 and proceed with scheduling appointments, which will be discussed in more detail below.

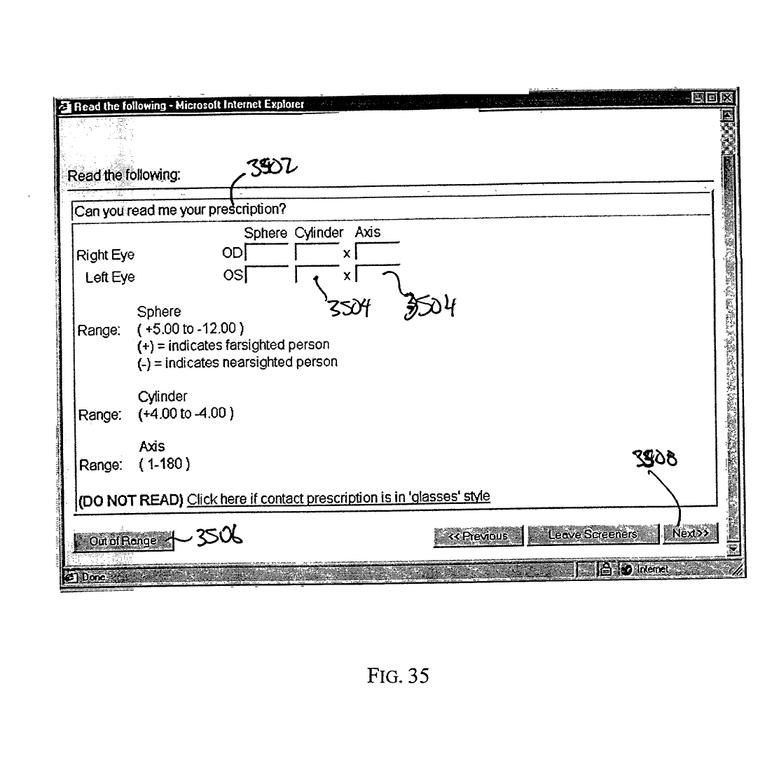

Referring back to query 1702 in FIG. 17 (see block 422 of FIG. 4A), if the answer is “Yes,” upon selection of the “Next” button 1708, the system logic causes the screen depicted in FIG. 33 to be displayed (see block 454 of FIG. 4B). In FIG. 33, the active scheduler is prompted to read query 3302. If the answer to the query is “This prescription is for glasses,” the active scheduler selects the radio button 3304, then selects the “Next” button 3308, and the system logic then displays the screen depicted in FIG. 34 (see block 456 of FIG. 4B). If the answer to the query 3302 is “This prescription is for contacts,” the active scheduler selects the radio button 3306, then selects the “Next” button 3308, and the system logic displays the screen depicted in FIG. 35 (see block 458 of FIG. 4B).

In each of FIGS. 34 (glasses) and 35 (contacts), the active scheduler is prompted to query the member as to whether the member can read the prescription to the active scheduler (see 3402 and 3502). The active scheduler then fills in the prescription information given by the member into the appropriate text boxes depicted in FIG. 34 (3404) or FIG. 35 (3504). Once the information has been entered, the active scheduler selects the “Next” button (3408 or 3508), which causes the system logic to display the screen depicted in FIG. 21 (see block 430 of FIG. 4B), and the logic flows similar to that described above from FIG. 21 to FIG. 32.

If the prescription given by the member for glasses (FIG. 34) or contacts (FIG. 35) is “Out of Range,” the active scheduler selects the “Out of Range” button, 3406 in FIG. 34 or 3506 in FIG. 35, which causes the system logic to display the screen depicted in FIG. 12 (see block 412 of FIG. 4A).

Referring back to FIG. 9, once the pre-screening questions have been answered and it is determined that the member is a good candidate for laser vision correction services, the active scheduler can then schedule an examination. The active scheduler preferably begins by clicking the “Laser Form” button 912 (FIG. 9), which causes the system logic to display to the active scheduler the screen depicted in FIG. 36 (see block 460 of FIG. 4A).

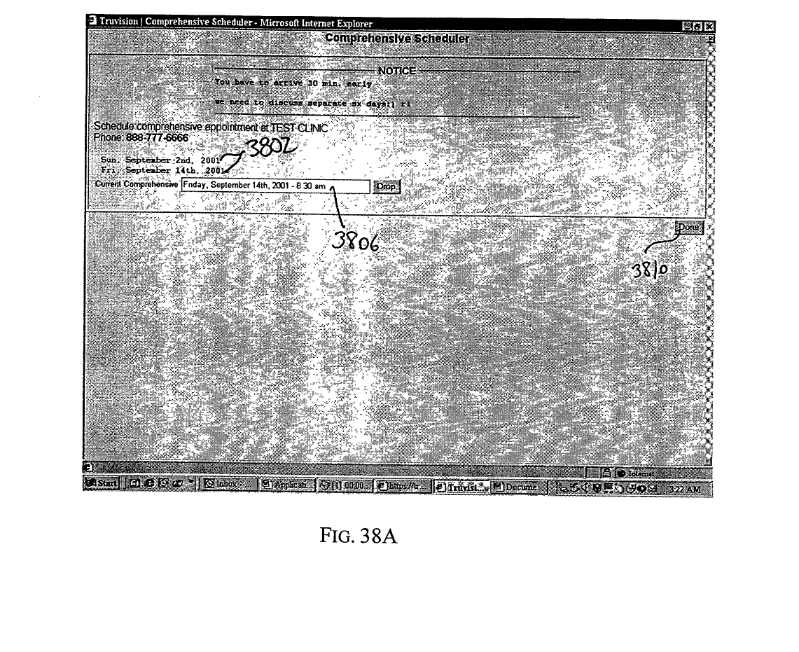

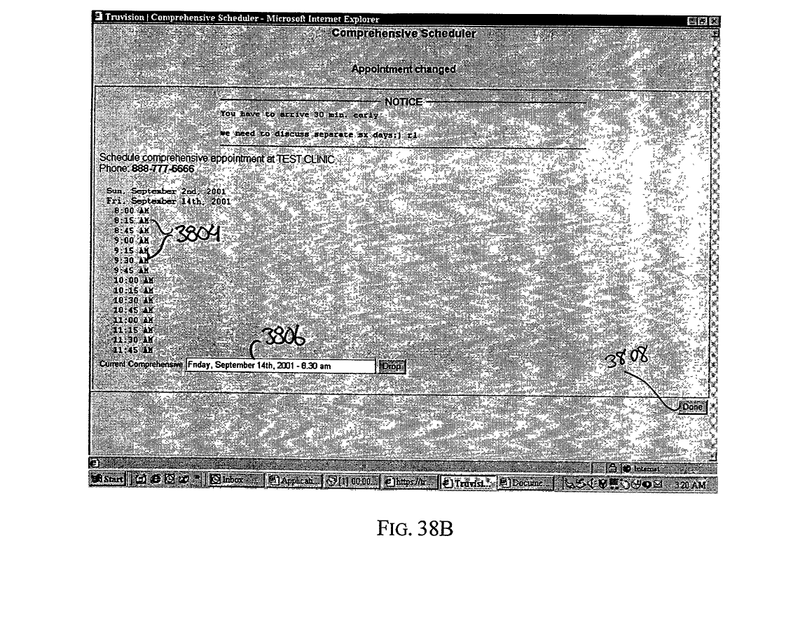

At FIG. 36, the active scheduler fills in the various text boxes 3610 depicted in FIG. 36. These text boxes request, among other things, the member's contact information. To schedule an appointment, the active scheduler clicks on the “Schedule” button 3614, in which case the system logic displays the screen depicted in FIG. 38A (see block 464 of FIG. 4A). The active scheduler then selects a date link 3802. Upon selection of a date, the system logic accesses the database to retrieve the available times 3804 (FIG. 38B) for a selected date that are currently available. The available dates and times are entered by any active schedulers in accordance with the procedures described below with respect to FIGS. 42 and 43. The active scheduler then selects from one of the time links 3804 (FIG. 38B). The selected date and time are then saved in the database as the appointment for that particular member, and the appointment information is reflected in the “Current Comprehensive” text box 3806 (FIGS. 38A and 38B). For example, in FIG. 38B (see block 466 of FIG. 4A), the date link selected in FIG. 38A was “Fri, Sep. 14, 2001” and the time link previously selected from FIG. 38B was 8:30 am. This results in a scheduled appointment on Friday, Sep. 14th, 2001 at 8:30 am as shown in the “Current Comprehensive” text box 3806 (FIGS. 38A and 38B). Clicking on the “Done” button 3808 (FIG. 38B) returns the active scheduler to the screen depicted in FIG. 38A. Clicking on the “Done” button 3810 (FIG. 38A) returns the active scheduler to the screen depicted in FIG. 36.

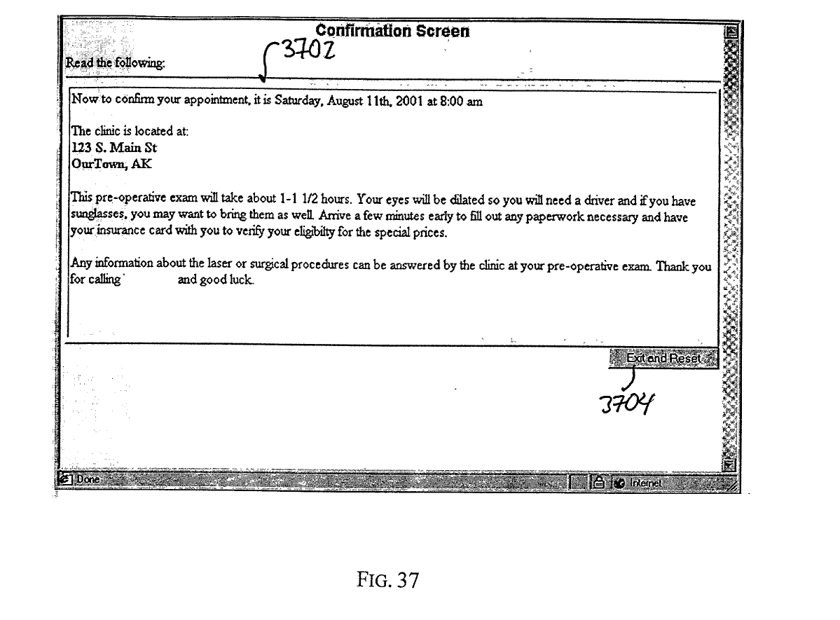

From the screen depicted in FIG. 36, clicking on the “Closing Script” button 3616 causes the system logic to display the screen depicted in FIG. 37 (see block 462 of FIG. 4A). FIG. 37 displays the member's appointment and prompts the active scheduler to read the information at 3702. After reading the information 3702, the active scheduler then selects the “Exit and Reset” button 3704, which causes the system logic to display the screen depicted in FIG. 10 (see block 408 in FIG. 4A).

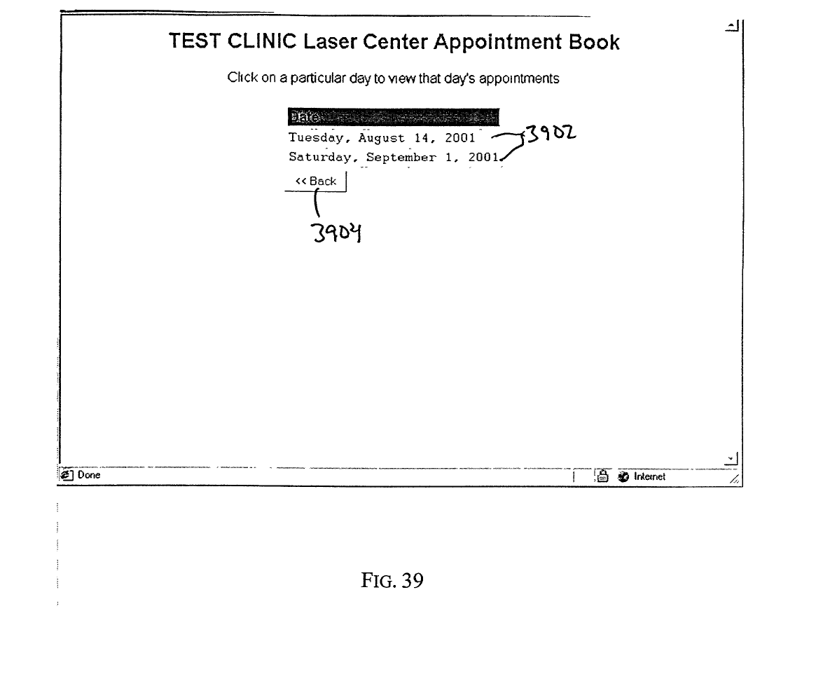

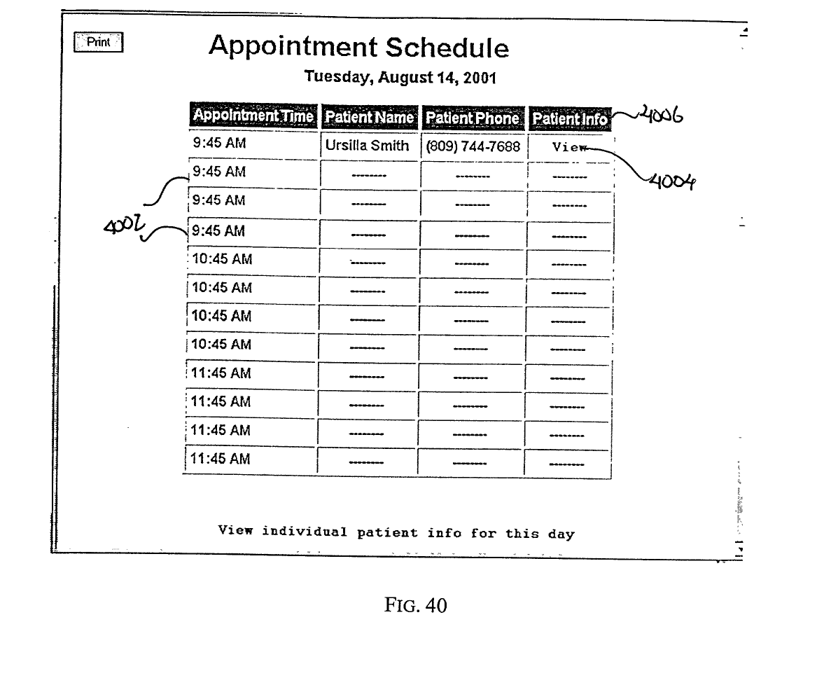

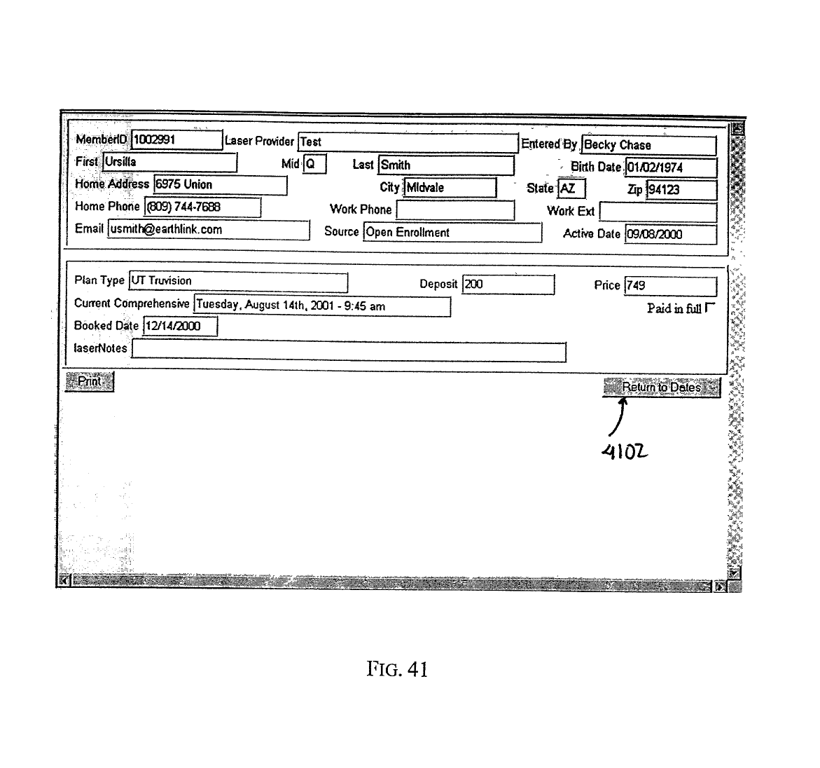

Referring back to the screen depicted in FIG. 36, clicking on the “Appointments” button 3612 causes the system logic to display the screen depicted as FIG. 39 (see block 468 of FIG. 4A). This allows for an active scheduler to view the current appointments for members by stepping through the screens depicted in FIGS. 39, 40 (see block 470 of FIG. 4A) and 41 (see block 472 of FIG. 4A). To return from FIG. 39 to FIG. 36, the active scheduler uses the “Back” button 3904.

With respect to FIG. 40, the patient information for any listed appointment may be viewed by clicking on the “View” link 4004 in the “Patient Info” column 4006. This causes the system logic to display the screen depicted in FIG. 41. To exit FIG. 41, the active scheduler must click on the “Return to Dates” button 4102, which causes the system logic to display FIG. 40.

Referring back to the portion of the screen-shot tree in FIG. 4A, if the active scheduler is a health services provider, screen access flows generally down the right side of the tree beginning with either FIG. 42 (see block 474 of FIG. 4A), FIG. 44 (see block 478 of FIG. 4A), or FIG. 48 (block 486 of FIG. 4A).

If the active scheduler selects the “Clinic Appointments” button 806 or “Warranty Appointments” button 808 in FIG. 8, the system logic displays FIG. 42 (see block 474 of FIG. 4A), which provide the active scheduler with the ability to edit the available appointments that can be scheduled. For example, in FIG. 42 if the active scheduler selects a laser center from the drop down menu 4204 and then selects the “Change” button 4206, the system logic displays FIG. 43 (see block 476 of FIG. 4A), which provides the active scheduler with the ability to add blocks of appointments 4302 or single appointments 4304. The active scheduler can also delete selected appointments 4306 and enter specific notes for any services provider location.

At this point, the active scheduler can select the “View Appointments” button 4308 in which the system logic displays the screen depicted in FIG. 39 discussed in more detail above.

If, from the screen displayed in FIG. 8, the active scheduler selects the “Clinic Forms” button 810, the system logic displays the screen depicted in FIG. 44. As shown in FIG. 44, the active scheduler has access to the members who have scheduled appointments through the Web-based system. The active scheduler can schedule appointments for members by selecting the “Schedule” button 4406 in which the system logic displays the screen depicted in FIG. 38A. The scheduling of an appointment then follows the same steps as described in more detail above with respect to FIGS. 38A and 38B.

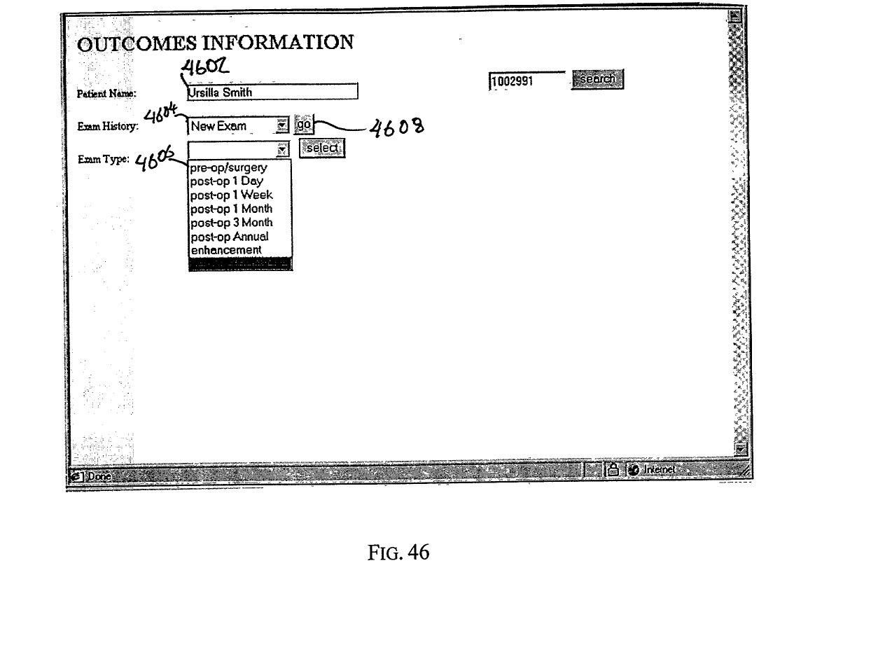

Clicking on the “Go To” pull down menu 4408 on FIG. 44 causes the system logic to display the screen depicted in FIG. 45 (see block 480 in FIG. 4A), which allows for the active scheduler to jump to various screens in the Web-based system. For example, as shown in FIG. 45, the active scheduler can select the “Outcomes” option 4506 in the “Go To” pull down menu 4408. This causes the system logic to display the screen depicted in FIG. 46 (see block 482 of FIG. 4A). Selection of the “Edit” option 4508 under either “Warranty Exams” or “Comprehensive Exams” results in the display of the screen depicted in FIG. 43, whereas selection of the “View” option 4510 under either “Warranty Exams” or “Comprehensive Exams” results in the display of the screen depicted in FIG. 39.

With respect to FIG. 46, if the active scheduler selects the Patient Name 4602, Exam History 4604, or Exam Type 4606, and then selects the “Go” button 4608, the system logic displays the screen depicted in FIG. 47 (see block 484 of FIG. 4A). Within FIG. 47, the active scheduler enters various information pertaining to surgical data and statistical tracking information as well as post-surgical data for each member. This data is then saved in the database 303 (FIG. 3). “Surgical data” is defined as any data relating to a surgical process such as the name of the doctor performing the surgery, the type of equipment used, and the type of procedure performed. “Post-correction data” or “post-surgical data” is any information that is collected after a surgical procedure is performed such as success data, post-correction eye testing data, and customer satisfaction.

FIG. 47 shows example information that can be entered and tracked. This information includes, but is not limited to, the doctor's name 4704, laser used 4706, types of eye drops 4708 prescribed to the member, and complications 4710. The information within the outcome forms can be any information that any active scheduler, particularly a services facilitator desires to keep track of. Preferably, the outcome information is stored in the database 303 and can be sorted and filtered to provide the health services facilitator, organizations, and health services providers with valuable utilization reports that, for example, detail the success rates of procedures and identify particularly effective surgeons.

Lastly, with respect to FIG. 8, if the active scheduler selects the “Appointment Checker” option 812, the system logic displays the screen depicted in FIG. 48 (see block 486 of FIG. 4A). This option provides an active scheduler with a list of any potential conflicts in appointments. If for any reason, two members have an appointment scheduled at conflicting times, the conflicts will be displayed on FIG. 48 so that they can be resolved by the services provider.

Another feature of the present invention is that the Web-based system provides for simple, automatic reminders and notifications to organizations and/or members of, for example, scheduled appointments and annual exams. In a preferred embodiment of the invention as applied in the laser eye surgery context, reminders and notifications are sent automatically via six emails. The first email is sent the day after the member schedules an appointment. This email may include, for example, the date, time, and location of the scheduled pre-operative examination. If the person is still considered a surgery candidate following the pre-operative examination, a second email is sent providing information concerning the surgery (e.g., the date, time, location, and requirements, which may include, for example, instructions about the proper clothing to wear, instructions not to wear perfume, and instructions to arrange for transportation following the surgery). The third email is sent, for example, the day after the surgery and provides information about the lifetime enhancement warranty. The fourth email is sent a week after the surgery and includes a customer satisfaction survey requesting feedback. The fifth email is sent forty-two weeks after the surgery and is an initial reminder that it is time for the member to schedule the first annual eye examination with a participating eye care provider to maintain the lifetime enhancement warranty. The sixth email is sent forty-eight weeks after the surgery and is a final reminder that the member needs to schedule the first annual eye examination to maintain the enhancement warranty.

In addition to laser vision correction services, the business model and Web-based system of the present invention include additional vision services such as contact lens programs and eyeglass programs. Offering a complete vision services package including laser vision correction services, contact lenses, and eyeglasses is beneficial to the organizations and the health services providers alike. The contact lenses and eyeglass aspects are described in more detail below.

With respect to contact lenses, the health services facilitator establishes relationships with manufacturers of contact lenses. These relationships allow the health services facilitator to eliminate warehousing and inventorying of contact lenses. It also allows the health services facilitator to offer contact lenses to anyone within the United States at significant discounts. All contacts are purchased via credit card, check, or money order prior to the order being shipped. Pre-payment via credit card, check, or money order generally results in a bad debt ratio of less than 1/100 of one percent of total revenue.

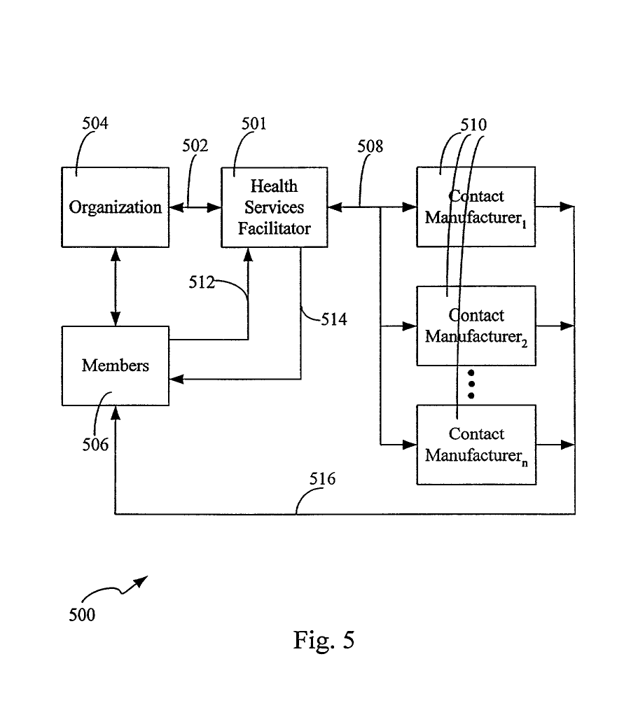

FIG. 5 is a schematic diagram illustrating a system 500 for facilitating the provision of contact lenses to members 506 of an organization 504 according to a second embodiment of the present invention. As illustrated in FIG. 5, this embodiment of the present invention comprises the steps of (a) establishing a health services facilitator 501; (b) establishing a first information-sharing relationship 502 between the health services facilitator 501 and an organization 504 having a plurality of members 506, wherein at least some of the plurality of members 506 need certain health services; (c) establishing a second information-sharing relationship 508 between the health services facilitator 501 and at least one contact lens manufacturer 510; (d) fielding at least one inquiry 512 from at least one of the plurality of members 506 and gathering information 512, 514 from the at least one of the plurality of members including the prescription, type of contacts worn, and delivery address; (e) receiving 512 a payment for the contacts; and (f) ordering 508 the contacts from a contact manufacturer 510 on behalf of the at least one of the plurality of members 506. The contact manufacturer 510 then ships 516 the contacts directly to the at least one of the plurality of members. The health services facilitator 501 obtains revenue, for example, by retaining a portion of the payment received from the member for the contact lenses.

In the contact lens embodiment of FIG. 5, the inquiries 512 are typically contact lens orders based on a prescription already obtained by the member 506. These inquiries are preferably through a communication system and may include questions concerning contact lenses in general. If necessary, based on the type of inquiry, the health services facilitator 501 may use the Web-based system 300 (FIG. 3) to schedule an examination for a member using a method similar to that described above with respect to laser vision correction. In this situation, the member is then referred to a participating doctor for examination.

The contact lens aspect according to the present invention is similar to other contact lens programs, which provide members with the ability to order less expensive contacts via the telephone or Internet and receive their lenses in 5-7 business days. The contact lens aspect according to the present invention, however, also has significant differences over existing contact lens programs. First, the organization 504 endorses the health services facilitator 501 through co-branding. Second, the health services facilitator 501 offers discounted contact lenses only to organization members. Third, because of its relationship with the organizations, the health services facilitator can purchase contact lenses directly from all major manufacturers. Fourth, the organization members pay no shipping costs. Fifth, the health services facilitator carries no inventory. Sixth, the health services facilitator sells its contact lenses for about 15-20% less than competitors.

With respect to eyeglasses, the health services facilitator's eyeglass program refers organization members to services providers such as optical stores, for discounts on eyeglasses, frames, and eye exams. Members can find participating optical stores by calling the health services facilitator or accessing the Internet. For purposes of this invention, “optical stores” include manufacturers and suppliers of contact lenses and eyeglasses, as well as locations where eye exams are performed (e.g., optical chains).

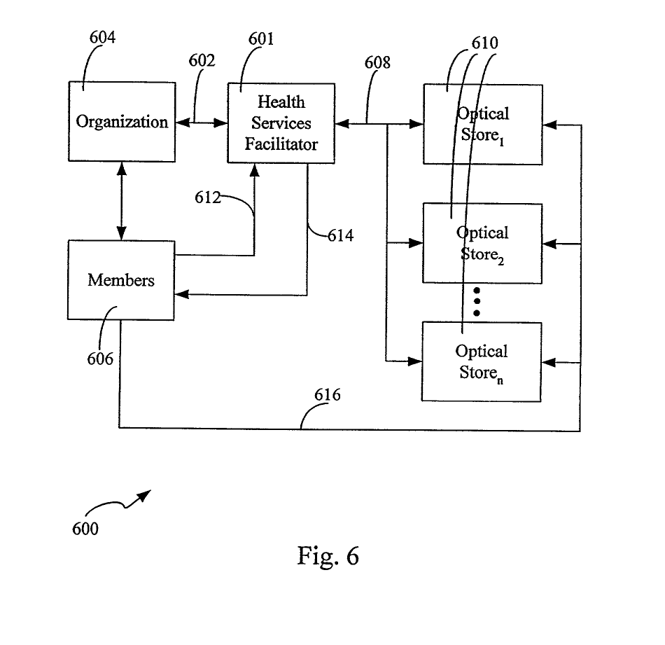

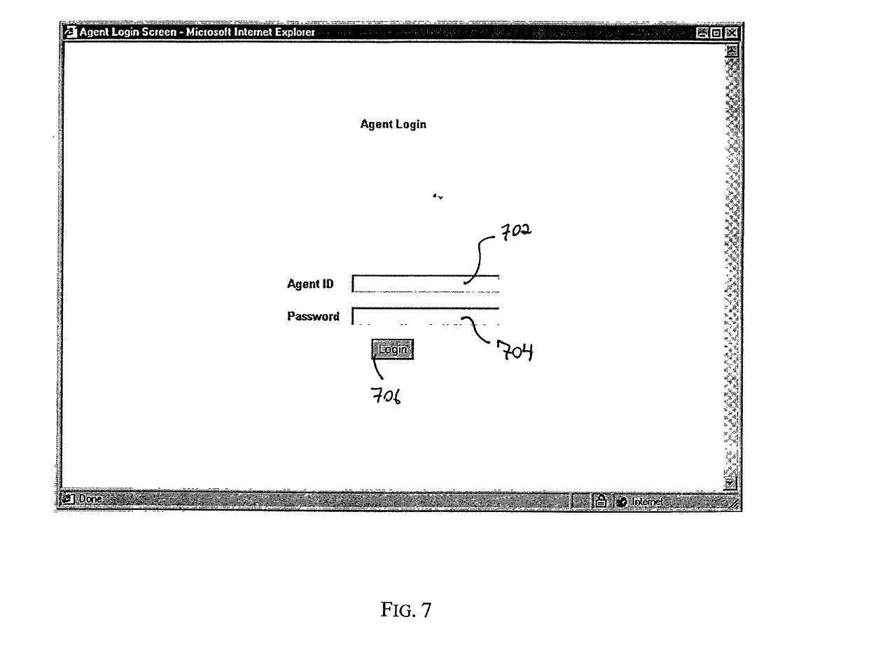

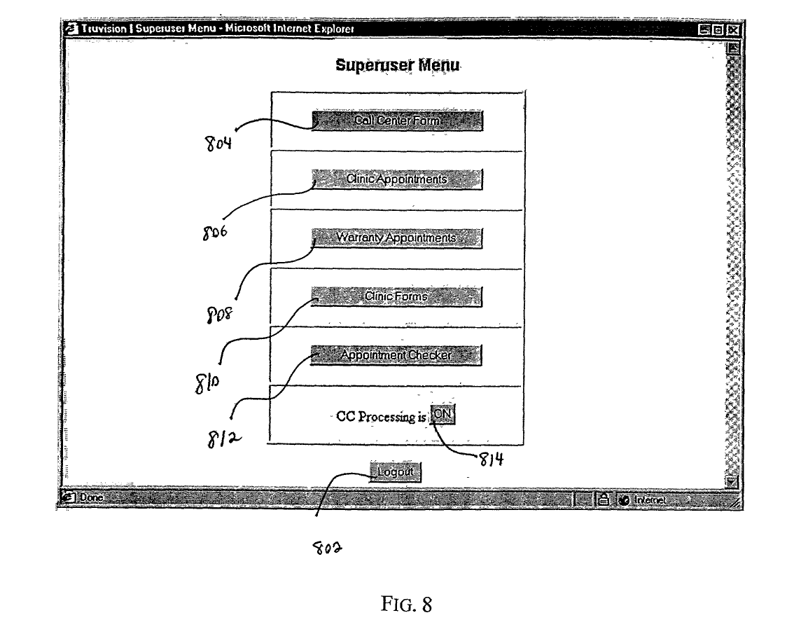

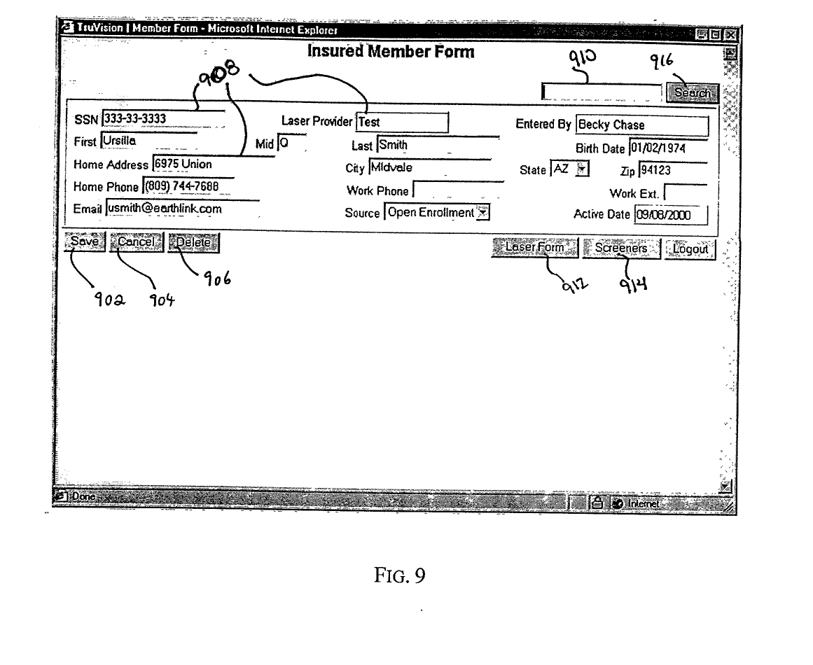

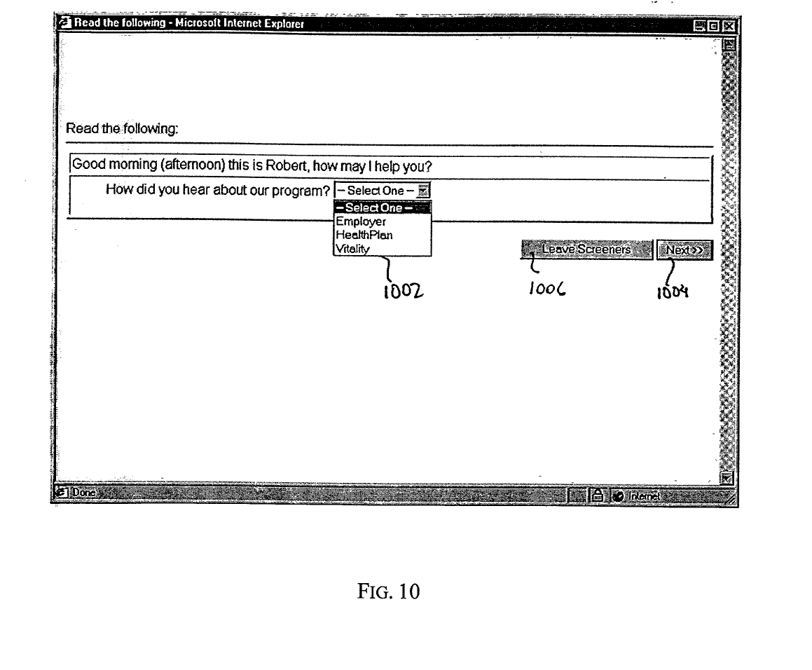

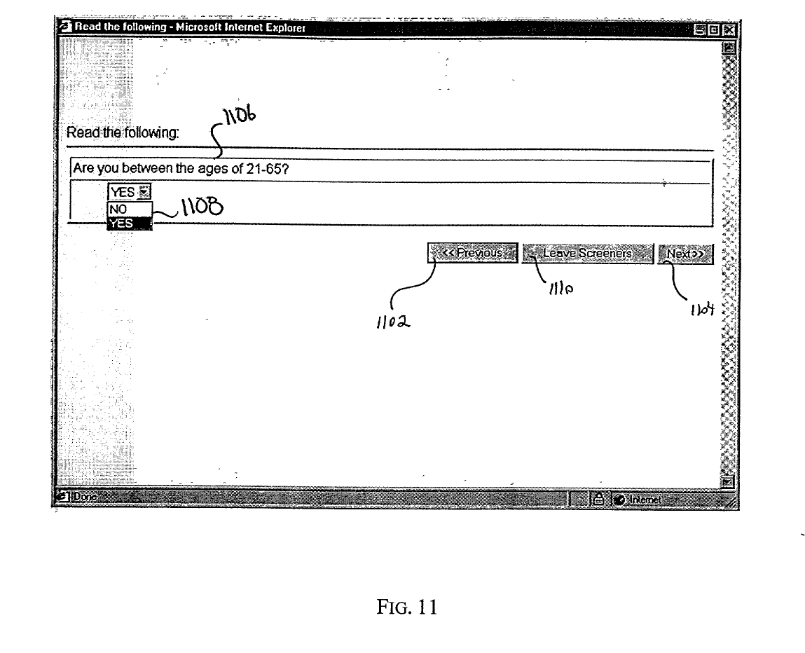

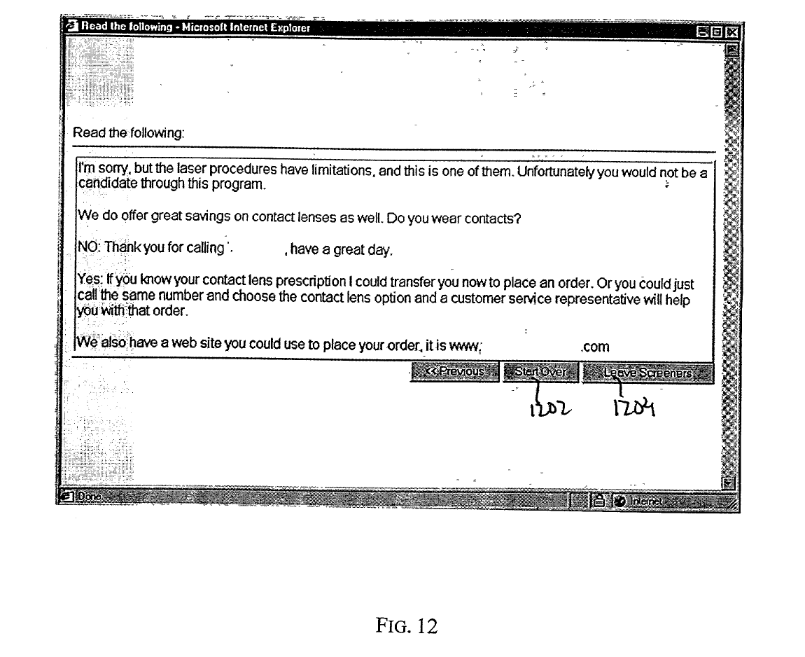

FIG. 6 is a schematic diagram illustrating a system 600 for facilitating the provision of eyeglasses to members 606 of an organization 604 according to a third embodiment of the present invention. As illustrated in FIG. 6, this embodiment of the present invention comprises the steps of (a) establishing a health services facilitator 601; (b) establishing a first information-sharing relationship 602 between the health services facilitator 601 and an organization 604 having a plurality of members 606, wherein at least some of the plurality of members 606 need eyeglasses; (c) establishing a second information-sharing relationship 608 between the health services facilitator 601 and at least one optical store 610; (d) fielding 614 at least one inquiry 612 from at least one of the plurality of members 606; and (e) referring 614 the member 606 to the optical store 610 based upon the inquiry. The referring step 614 according to this embodiment preferably occurs by the health services facilitator 601 informing the member 606 of participating optical stores 610. The member then contacts 616 the optical store 610 either in person or through a communication system.

Frames under the eyeglass program are preferably sold at wholesale plus 25%. This is significant because frames are normally sold for 300-400% above wholesale. Discounts of up to 20% off are also offered on lenses and eye exams. The health services facilitator 601 obtains revenue, for example, through a pre-negotiated referral amount paid by the optical store if the member purchases frames or eyeglasses, or gets an eye exam.

The discounts are substantial as a result of the relationship between the health services facilitator and the organizations. The organizations typically have a significant number of members. These large numbers are particularly appealing to eyeglass manufacturers from a referral standpoint and thus these manufacturers give larger discounts to participating organizations.

The present methods and apparatus have been described in detail while making reference to specific embodiments thereof. However, since it is known that others skilled in the art will, upon learning of the invention, readily visualize yet other embodiments of the invention and similar applications in other areas that are within the spirit and scope of the present invention, it is not intended that the above description be taken as a limitation on the spirit and scope of this invention.

We claim:

1. A method of facilitating the provision of services to individuals, said method comprising the steps of
(a) establishing a services facilitator;
(b) establishing a first information-sharing relationship between said services facilitator and an organization having a plurality of members, wherein at least some of said plurality of members need certain services;
(c) establishing a second information-sharing relationship between said services facilitator and at least one services provider that provides said certain services;
(d) fielding at least one inquiry from at least one member of said plurality of members; and
(e) referring said at least one member to said at least one services provider based upon said at least one inquiry.

2. The method of claim 1, wherein said services facilitator is an entity separate from said organization and from said at least one services provider.

3. The method of claim 1, wherein said organization is one of a health plan and a corporation.

4. The method of claim 1, wherein said certain services comprise health services.

5. The method of any one of claims 1, 3, and 4, wherein said step (b) further comprises
establishing a discounted prices program for said certain services; and
offering said discounted prices program to said organization in exchange for access to contact information for said plurality of members.

6. The method of claim 5, wherein said step (b) further comprises offering said discounted prices program to said organization with no monthly premium or access fees.

7. The method of any one of claims 1, 3, and 4, wherein said step (b) further comprises providing at least one of the following services to said organization in exchange for access to contact information for said plurality of members: marketing, administration, and pre-screening.

8. The method of claim 1, wherein said step (c) further comprises providing at least one of the following services to said at least one services provider in exchange for an agreement from said services provider to provide said certain services at discounted prices: marketing, administration, and pre-screening.

9. The method of claim 8, wherein said method further comprises the step of marketing said certain services to said plurality of members.

10. The method of claim 8, wherein said marketing step further comprises said organization endorsing said certain services offered by said at least one services provider.

11. The method of claim 1, wherein said at least one services provider is at least one of a laser care provider and an optical store.

12. The method of claim 1, wherein said method further comprises said services facilitator administering a communication system that links said services facilitator to said at least one services provider and to said at least one member.

13. The method of claim 12, wherein said communication system comprises
a first communication system that links said services facilitator to said at least one services provider; and
a second communication system that links said services facilitator to said at least one member; and wherein said administering step further comprises said services facilitator
operating said first communication system;
operating said second communication system;
monitoring said second communication system for said at least one inquiry from said at least one member;
fielding said at least one inquiry from said at least one member; and
directing said at least one member to said at least one services provider based upon said at least one fielded inquiry.

14. The method of claim 13, wherein said first communication system is different from said second communication system.

15. The method of claim 13, wherein said operating said second communication system step further comprises establishing an in-house telephonic communications center capable of receiving at least one of telephone calls and facsimile transmissions from said plurality of members.

16. The method of claim 13, wherein said operating said second communication system step further comprises establishing a cooperative relationship with at least one overflow telephonic communications center capable of receiving at least one of telephone calls and facsimile transmissions from said plurality of members.

17. The method of any one of claims 15 and 16, wherein said operating said second communication system step further comprises
assigning a unique telephonic communications number to said organization; and
announcing said unique telephonic communications number to said plurality of members.

18. A method of facilitating the provision of health services to individuals, said method comprising the steps of:
(a) establishing a health services facilitator;
(b) establishing a first information-sharing relationship between said health services facilitator and an organization having a plurality of members, wherein at least some of said plurality of members need certain health services;
(c) establishing a second information-sharing relationship between said health services facilitator and at least one health services provider that provides said certain health services;
(d) fielding at least one inquiry from at least one member of said plurality of members;
(e) referring said at least one member to said at least one health services provider based upon said at least one inquiry; and
(f) administering a Web-based system that links said health services facilitator to said at least one health services provider.

19. The method of claim 18, wherein said Web-based system enables said health services facilitator to do at least one of the following tasks: fielding said at least one inquiry from said at least one member, scheduling an appointment for said at least one member, and tracking outcomes of said certain health services provided to said at least one member.

20. The method of claim 18, wherein said Web-based system further links said health services facilitator to said plurality of members in real time.

21. The method of claim 18, wherein said Web-based system further links said health services facilitator to said at least one health services provider in real time.

22. The method of claim 18, wherein said administering step further comprises operating an in-house call center capable of receiving telephonic communications from said plurality of members.

23. The method of claim 22, wherein said administering step further comprises establishing a cooperative relationship with at least one overflow call center capable of receiving telephonic communications from said plurality of members.

24. The method of claim 23, wherein said Web-based system further links said health services facilitator to said in-house call center and to said at least one overflow call center in real time.

25. The method of claim 18, wherein said certain health services comprise performing laser vision correction, and wherein said at least one health services provider is a laser care provider.

26. The method of claim 25, wherein said laser care provider is at least one of a laser vision correction center and an independent refractive surgeon.

27. The method of claim 25, wherein said communication system further comprises a customer service center capable of receiving telephonic communications from said plurality of members; wherein said Web-based system links said health services facilitator to said customer service center; and wherein said administering step further comprises operating said customer service center.

28. The method of claim 27, wherein said customer service center is at least one of an in-house call center and an overflow call center.

29. The method of claim 27, wherein said Web-based system enables one of said customer service center and said health services provider to do at least one of the following tasks: fielding questions from said plurality of members, pre-screening said plurality of members, and scheduling appointments.

30. The method of claim 29, wherein said Web-based system enables one of said customer service center and said health services provider to track outcomes from laser vision correction procedures.

31. The method of claim 25, wherein said step (c) further comprises providing at least one of the following services to said laser care provider in exchange for an agreement from said laser care provider to perform laser vision correction at discounted prices: marketing, administration, and pre-screening.

32. The method of claim 25, wherein said step (c) further comprises said health services facilitator providing the following services to said laser care provider in exchange for an agreement from said laser care provider to perform laser vision correction at discounted prices:
generating marketing materials for a laser vision correction program;
distributing said marketing materials to said plurality of members;
receiving real-time available-appointment information from said laser care provider via said Web-based system;
pre-screening said at least one of member to determine that said at least one member is a potential customer for said certain health services;
collecting information about said at least one member;
receiving a deposit from said at least one member for said laser vision correction; and
scheduling a screening examination for said at least one member directly with said laser care provider via said Web-based system based upon said real-time available-appointment information.

33. The method of claim 32, wherein said step (c) comprises said health services facilitator educating said plurality of members on laser vision correction in further exchange for said agreement from said laser care provider to perform laser vision correction at discounted prices.

34. The method of claim 32, wherein said step (c) comprises said health services facilitator providing the following further services to said laser care provider in exchange for said agreement from said laser care provider to perform laser vision correction at discounted prices:
tracking completed laser vision correction procedures, cancellations, reasons for cancellations, surgical outcomes, and statistical data;
creating utilization reports based upon said tracking; and
screening for medical conditions that may affect stability of laser vision correction.

35. The method of claim 32, wherein said collecting information about said at least one member step further comprises pre-screening said at least one member for medical conditions that may affect suitability of said at least one member for laser vision correction.

36. The method of claim 32, wherein said marketing materials offer an enhancement warranty comprising discounted follow-up procedures assuming said at least one member has annual eye exams with a participating eye care provider.

37. The method of claim 25, wherein said laser vision correction is performed according to a laser vision correction program, wherein said laser vision correction program comprises the following steps:
said health services facilitator establishing a discounted prices program with said laser care provider;
said health services facilitator offering said discounted prices program to said organization in exchange for access to contact information for said plurality of members;
said health services facilitator generating marketing materials for said discounted prices program;
said health services facilitator distributing said marketing materials to said plurality of members;
said laser care provider furnishing available-appointment information to said health services facilitator via said Web-based system in real time;
said health services facilitator receiving said available-appointment information in real time;
said health services facilitator pre-screening said at least one member to determine that said at least one member is a potential customer for said laser vision correction;
said health services facilitator collecting information about said at least one member;
said health services facilitator receiving a deposit from said at least one member for said laser vision correction;
said health services facilitator scheduling a screening examination for said at least one member directly with said laser care provider via said Web-based system based upon said real-time available-appointment information; and
said laser care provider performing said screening examination.

38. The method of claim 37, wherein said laser vision correction program further comprises the following steps:
said laser care provider determining from said screening examination that said at least one member is ineligible for laser vision correction;
said laser care provider entering ineligibility information into said Web-based system; and
said health services facilitator refunding said deposit to said at least one member.

39. The method of claim 37, wherein said laser vision correction program further comprises the following steps:
said laser care provider determining from said screening examination that said one member is eligible for laser vision correction;
said laser care provider entering eligibility information and surgical data into said Web-based system;
said laser care provider collecting a balance due for said laser vision correction; and
said laser care provider performing said laser vision correction.

40. The method of claim 39, wherein said laser vision correction program further comprises the following steps:
said laser care provider entering post-correction data into said Web-based system; and
said laser care provider entering follow-up, post-correction data into said Web-based system.

41. The method of claim 39, wherein said laser care provider enters said follow-up, post-correction data into said Web-based system at predetermined intervals.

42. The method of claim 41, wherein said predetermined intervals include within one month of said laser vision correction, within three months of said laser vision correction, and within six months of said laser vision correction.

43. The method of any one of claims 37 and 39, wherein said laser vision correction program further comprises the following steps:
said health services facilitator offering an enhancement warranty; and
said laser care provider honoring said enhancement warranty.

44. The method of claim 43, wherein said enhancement warranty comprises discounted follow-up procedures for said at least one member assuming said at least one member has an annual eye exam with a participating eye care provider.

45. A method of receiving and processing information in real time over a network, said method comprising the steps of
establishing a site on a global communication network;
providing a central server connected to said site on said global communication network, said central server accessing a dynamic database;
recognizing an active scheduler;
prompting said active scheduler with information stored by said central server to collect information for a plurality of fields within said dynamic database;
receiving said collected information from said active scheduler;
processing said collected information by said central server; and
updating said dynamic database to reflect said collected information prior to recognizing a second active scheduler.

46. The method of claim 45, wherein said active scheduler is at least one of a call center, a clinic, and an administrator.

47. The method of claim 45, wherein said prompting said active scheduler step further comprises presenting scripted statements to said active scheduler, said scripted statements being stored by said central server and transferred from said central server over said global communication network to said active scheduler.

48. A method of scheduling appointments and compiling statistical data in real-time over a network, said method comprising the steps of
establishing a site on a global communication network;
providing a central server connected to said global communication network, said central server having a dynamic database;
recognizing at least one of a call center, a clinic, and an administrator as an active scheduler;
prompting said active scheduler to collect information for a plurality of fields within said dynamic database;
receiving collected information from said active scheduler;
storing said collected information;
updating said dynamic database to reflect said collected information prior to recognizing a second active scheduler;
scheduling appointments in real time based upon said collected information and making details concerning said scheduled appointments selectively available over said global communication network; and
compiling statistical data in real time based upon said collected information and making details concerning said compiled statistical data selectively available over said global communication network.

49. A system for linking a plurality of health services providers, a health services facilitator, and a plurality of members to provide real-time scheduling of appointments, to pre-qualify members for specific services, and to compile statistical tracking data over a network, said system comprising
a central server having a predetermined set of prompts and being capable of storing scheduling information, pre-qualifying information, and statistical tracking data pertaining to said plurality of health services providers, said health services facilitator, and said plurality of members in a database;
a communication link allowing transfer of said scheduling information, pre-qualifying information, and statistical tracking data between at least one of said plurality of members and at least one of said health services facilitator and said plurality of health services providers; and
at least one remote communication terminal connected to said central server through a global computer network on which said plurality of health services providers and said health services facilitator receive said predetermined set of prompts from said central server and enter said pre-qualifying information, said scheduling information, and said statistical tracking data obtained from said at least one of said plurality of members through said communication link or independently entered by said plurality of health services providers and said health services facilitator in response to said predetermined set of prompts.
